(19) United States
(12) Patent Application Publication
(10) Pub. No.: US 2024/0240036 A1
(43) Pub. Date: Jul. 18, 2024

(54) SOLID-INFUSED SURFACES, ARTICLES INCORPORATING SOLID-INFUSED SURFACES, METHODS OF MAKING, AND METHODS OF USE THEREOF

(71) Applicant: VIRGINIA TECH INTELLECTUAL PROPERTIES, INC., Blacksburg, VA (US)

(72) Inventors: Ranga PITCHUMANI, Herndon,, VA (US); Ryan STODDARD, Radford, VA (US)

(21) Appl. No.: 18/559,525

(22) PCT Filed: May 7, 2022
(86) PCT No.: PCT/US22/28232

§ 371 Date: Nov. 7, 2023

Related U.S. Application Data
(60) Provisional application No. 63/185,973, filed on May 7, 2021.

(51) Int. Cl. C09D 5/16; C23F 1/18

(52) U.S. Cl. CPC C09D 5/1681; C23F 1/18

(57) ABSTRACT

Solid-infused surfaces and articles having solid-infused surfaces are provided. The solid-infused surface includes (a) a substrate with a roughened surface having multi-scale surface roughness and a plurality of substrate asperities, and (b) a low surface-energy polymer coating a portion of the roughened surface forming the solid-infused surface having a fraction of the substrate asperities exposed on the solid-infused surface. The surfaces can be useful, in particular, for promoting condensation heat transfer performance. The articles and surfaces can include electronic components, optical components, or even pipes and other conduits for transporting certain fluids. Methods of making and methods of using the solid-infused surfaces are also provided.

### CROSS-REFERENCE TO RELATED APPLICATIONS

This application claims priority to, and the benefit of, co-pending U.S. provisional application entitled “SOLID-INFUSED SURFACES FOR HIGH EFFICIENCY CONDENSATION” having Ser. No. 63/185,973 filed May 7, 2021, the contents of which are incorporated by reference herein.

### STATEMENT REGARDING FEDERALLY SPONSORED RESEARCH OR DEVELOPMENT

This invention was made with government support under award DE-FE0031556 awarded by the Department of Energy. The government has certain rights in the invention.

### TECHNICAL FIELD

The present disclosure generally relates to engineered surfaces, and in particular to surfaces which can be engineered to resist wetting and/or resist fouling.

### BACKGROUND

Surfaces modified to induce nonwettability have been demonstrated to deter fouling due to their propensity to repel water and thereby mitigate mineral accumulation. Nonwetting surfaces conventionally studied in the literature include superhydrophobic surfaces and lubricant-infused in which an air cushion or a lubricant fluid in the asperity interstices increases the water contact angle (≳120° and as high as 170°) and reduces the water sliding angle (≲10° and as low as 2-3°). (See e.g., R. Jain and R. Pitchumani, Facile Fabrication of Durable Copper-Based Superhydrophobic Surfaces via Electrodeposition. Langmuir, 34(10) (2017), 3159-3169. and R. Stoddard, K. Nithyanandam and R. Pitchumani, Fabrication and Durability Characterization of Superhydrophobic and Lubricant-Infused Surfaces. Journal of Colloid and Interface Science, 608, (2022), 662-672). Nonwetting surfaces have shown great potential for drag reduction, enhanced convection, enhanced phase change heat transfer, and reduced corrosion reduction (see for example references 13-21 in Example 2). Use of nonwetting surfaces to deter fouling is also reported in the literature, focusing mostly on biofouling whereas the limited studies on mineral fouling are restricted to calcium sulfate and calcium carbonate deposition on surfaces immersed in a static fluid medium. reduction (see for example references 22-27 in Example 2).

There is a little reported information on dynamic flow fouling on nonwetting surfaces and surfaces such as lubricant-infused surfaces are prone to lubricant depletion under such conditions.

Furthermore, fabrication of superhydrophobic and lubricant-infused surfaces is not readily scalable to large-scale manufacturing owing to the need to fabricate precise nano-scale textures surfaces.

There remains a need for improved surfaces for reducing wetting and/or fouling, especially in dynamic flow conditions.

There further remains a need for improved surfaces for reducing wetting and/or fouling that can reduce fouling by minerals such as sulfates, carbonates, phosphates, and other minerals.

There also remains a need for improved surfaces for reducing wetting and/or fouling that are easier to produce at large scale for a variety of applications.

### SUMMARY OF THE DISCLOSURE

In various aspects, solid-infused surfaces, articles having solid-infused surfaces, and methods of making solid-infused surfaces are provided that overcome one or more of the aforementioned deficiencies. In various aspects, solid-infused surfaces are provided as well as articles having a solid-infused surface. The solid-infused surface can include (a) a substrate having a roughened surface having multi-scale surface roughness and a plurality of substrate asperities, and (b) a low surface-energy polymer coating a portion of the roughened surface forming the solid-infused surface having a fraction of the substrate asperities exposed on the solid-infused surface.

Suitable substrates can include substrates capable of being etched or roughened using methods known in the art such as chemical etching, electrodeposition, lithography, oxidation via electrodeposition, nanoparticle composite coating, thermal spraying, plasma spraying, high velocity oxygen fuel (HOVF) coating, and combinations thereof. For example, in some instances the substrates include a substrate selected from the group consisting of copper, tin, iron, zinc, manganese, carbon, silicon, tin, chromium, phosphorous, alloys thereof, and combinations thereof. In some aspects, when it is important to promote nucleation and dropwise condensation for condensation heat transfer and antifouling applications, the substrate can have a surface energy higher than the surface energy of the low surface-energy polymer.

Suitable low surface-energy polymers can include of nylon, polybutadiene, polyethylene (PE), polychlorotrifluoroethylene (PCTFE), polypropylene (PP), polydimethylsiloxane (PDMS), poly t-butyl methacrylate (PtBMA), fluorinated ethylene propylene (FEP), hexatriacontane, paraffin, polytetrafluoroethylene (PTFE), poly(hexafluoropropylene), polyisobutylene (PIB, butyl rubber), silicone, polyester, polyester, polyurethane, copolymers, thereof, and blends thereof.

The solid-infused surfaces can be useful on a variety of articles including an inner or outer surface of a pipe or conduit such as for a radiator, a solar panel or a component thereof, or any container, pipeline, nozzle, valve, conduit, vessel, bottle, mold, die, chute, bowl, tub, bin, cap for a bottle or container, tube, or combination thereof.

In various aspects, methods of making a solid-infused surface on an article are also provided. The methods can include (a) roughening a surface of a substrate to produce a roughened surface having multi-scale surface roughness and a plurality of substrate asperities, and (b) coating a portion of the roughened surface with a low surface-energy polymer to form the solid-infused surface having a fraction of the substrate asperities exposed on the solid-infused surface.

Various other aspects of the solid-infused surfaces, articles, and methods will be better understood upon reviewing the disclosure, figures, and aspects described below.

### BRIEF DESCRIPTION OF THE DRAWINGS

Further aspects of the present disclosure will be readily appreciated upon review of the detailed description, described below, when taken in conjunction with the accompanying drawings.

FIG. 1A is a schematic of an exemplary two-step process for forming a solid-infused surface whereby a surface of an article is etched via chemical etching to form a textured surface in a first step followed by a coating step whereby a plurality of asperities in the textured surface are at least partially filled with a polymer coating. FIG. 1B is a surface micrograph of an exemplary textured copper surface prepared by chemical etching. FIG. 1C is a surface micrograph of an exemplary solid-infused surface prepared by coating the textured copper surface depicted in FIG. 1B with a polymer. FIG. 1D is a schematic depicting (left panel) the film-wise condensation of water droplets on an untreated roughened copper surface such as that depicted in FIG. 1B and (right panel) the drop-wise condensation of water droplets on the solid-infused surface such as that depicted in FIG. 1C.

FIG. 2 shows a schematic of an experimental apparatus used for testing condensation behavior of copper pipes having different surfaces and insets showing (top) a solid-infused surface showing dropwise condensation (middle) a lubricant-infused surface showing dropwise condensation, and (bottom) an untreated copper tube showing filmwise condensation.

FIG. 3A is a graph of the condensation heat transfer coefficient of exemplary copper tubing having a solid-infused surface (SIS), a lubricant-infused surface (LIS), and an untreated surface as a function of the temperature difference. FIG. 3B is a schematic of a heat transfer circuit.

FIG. 4 is a graph of the heat transfer effectiveness as a function of the condensation heat transfer coefficient for exemplary copper tubing having a solid-infused surface (SIS), a lubricant-infused surface (LIS), and an untreated surface.

FIG. 5 is a schematic of a setup for heat transfer fouling experiments.

FIG. 6 is a graph of profilometric scans of (a) smooth and (b) etched copper tubes.

FIG. 7A is an SEM image of as fabricated smooth copper surface with contact angle measurements for a water droplet depicted in the inset. FIG. 7B is an SEM image of as fabricated superhydrophobic copper surface with contact angle measurements for a water droplet depicted in the inset. FIG. 7C is an SEM image of as fabricated lubricant-infused copper surface with contact angle measurements for a water droplet depicted in the inset. FIG. 7D is an SEM image of as fabricated solid-infused copper surface with contact angle measurements for a water droplet depicted in the inset. FIG. 7E is a three-dimensional isometric view of as-fabricated etched copper surface. FIG. 7F is a three-dimensional isometric view of as-fabricated Gentoo cured solid-infused copper surface.

FIG. 8A is an SEM image of fouled smooth copper surface. FIG. 8B is an SEM image of fouled superhydrophobic copper surface. FIG. 8C is an SEM image of fouled lubricant infused copper surface. FIG. 8D is an SEM image of folded solid-infused copper surface.

FIG. 9A is a series of progressively zoomed-in SEM images of a silica fouled smooth copper surface. FIG. 9B is a series of progressively zoomed-in SEM images of a silica fouled superhydrophobic copper surface. FIG. 9C is a series of progressively zoomed-in SEM images of a silica fouled lubricant-infused copper surface. FIG. 9D is a series of progressively zoomed-in SEM images of a silica folded solid-infused copper surface.

FIG. 10A is a graph of the variation for fouling resistance (R_{f}) with time (t) for a range of fluid flow temperatures for a smooth copper surface. FIG. 10B is a graph of the variation for fouling resistance (R_{f}) with time (t) for a range of fluid flow temperatures for a superhydrophobic copper surface. FIG. 10C is a graph of the variation for fouling resistance (R_{f}) with time (t) for a range of fluid flow temperatures for a lubricant-infused copper surface. FIG. 10D is a graph of the variation for fouling resistance (R_{f}) with time (t) for a range of fluid flow temperatures for a solid-infused copper surface.

FIG. 11A is a graph of the variation of asymptotic fouling resistance with flow temperature for all the surface types studied. FIG. 11B is a graph of Arrhenius relationship of R_{f∞} with absolute temperature.

FIG. 12A is an SEM image of the inside of an exemplary clean copper tube with contact angle measurements for a water droplet depicted in the inset. FIG. 12B is an SEM image of the inside of an exemplary as-fabricated lubricant-infused surface of a copper tube with contact angle measurements for a water droplet depicted in the inset. FIG. 12C is an SEM image of the inside of an exemplary as-fabricated solid-infused surface of a copper tube with contact angle measurements for a water droplet depicted in the inset.

FIG. 13 is a schematic of the forced convection experimental setup for heat transfer fouling.

FIG. 14A is a set of SEM images of calcium-sulfate folded smooth surface of an exemplary copper tube. FIG. 14B is a set of SEM images of calcium-sulfate folded lubricant-infused surface of an exemplary copper tube. FIG. 14C is a set of SEM images of calcium-sulfate folded solid-infused surface of an exemplary copper tube.

FIG. 15 is a graph of the variation of fouling resistance, R_{f}, with time, t, for relatively high (Re=1000) and low (Re=2000) fouling conditions of calcium sulfate on solid-infused surface.

FIG. 16A is a graph of the variation of asymptotic fouling resistance with Reynolds number for smooth, SIS and LIS surfaces. FIG. 16B is a graph of the variation of asymptotic fouling resistance with foulant concentration ratio for smooth, SIS and LIS surfaces. FIG. 16C is a graph of the variation of asymptotic fouling resistance with foulant temperature for smooth, SIS and LIS surfaces.

FIG. 17A is a graph comparing experimental asymptotic fouling resistance values with the corresponding values from the correlations for solid-infused surfaces. FIG. 17B is a graph comparing experimental asymptotic fouling resistance values with the corresponding values from the correlations for smooth surfaces.

FIG. 18 is a graph of contours of percentage fouling reduction of SIS relative to smooth surface as a function of Reynolds number and fouling concentration ratio for T=(a) 293 K and (b) 323 K.

FIG. 19 is a graph of the variation of retained lubricant volume fraction on LIS with Reynolds number.

FIG. 20A is a SEM image of a lubricant-infused surface before shear. FIG. 20B is a SEM image of a lubricant-infused surface after exposure to shear. FIG. 20C is a SEM image of a solid-infused surface before shear. FIG. 20D is a SEM image of a solid-infused surface after exposure to shear.

FIG. 21A is a graph of the variation of the differential asymptotic fouling resistance, ΔR_{f∞}, for SIS and LIS with Reynolds number. FIG. 21B is a graph of the variation of the asymptotic fouling resistance before and after durability experiments for SIS and LIS in comparison to the smooth surface. as a function of the Reynolds number.

### DETAILED DESCRIPTION

In various aspects described herein are solid-infused surfaces. Solid-infused surfaces can include (a) a substrate having a roughened surface having multi-scale surface roughness and a plurality of substrate asperities, and (b) a low surface-energy polymer coating a portion of the roughened surface forming the solid-infused surface having a fraction of the substrate asperities exposed on the solid-infused surface. Further, in various aspects described herein are methods of making the solid-infused surfaces.

For example, in some aspects solid-infused surfaces are described herein that include a copper substrate that has been roughened by chemical etching to have a multi-scale roughness and a plurality of copper asperities. A portion of the roughened surface is coated by a Gentoo® polymer (a low surface-energy polymer) leaving a fraction of the copper asperities exposed on the solid-infused surface.

Not wishing to be bound by any particular theory, it is believed that the solid copper asperities protruding out of the infused cured Gentoo polymer are high energy density spots that attract condensate nucleation, and droplet growth thereafter. At a certain critical radius of the condensate droplet the coalescence and subsequent growth results in the presence of condensate droplets on a composite surface of solid asperities and infused material. The non-wetting nature of the Gentoo polymer infusion material leads to early and frequent removal of condensate droplets leading to enhanced condensation heat transfer. Therefore, existence of solid asperities protruding out of the infuse material and the presence of non-wetting infusion material itself are both believed to be of importance as well as the multi-scale roughness of the surface (for example, as measured by the fractal dimension of the surface). As the role of the solid asperities is to promote condensate droplet nucleation, only a small area fraction can be sufficient in some instances. In addition, it is believed that the more the area fraction of infusion material higher the frequency of the condensate shedding which contributes significantly towards the overall condensation heat transfer performance. In some aspects, a solid area fraction of the exposed substrate asperities on the solid-infused surface is about 0.01 to about 0.30, about 0.01 to about 0.25, about 0.01 to about 0.20, about 0.02 to about 0.20, about 0.03 to about 0.20, about 0.03 to about 0.15, about 0.04 to about 0.15.

Other systems, methods, features, and advantages of solid-infused surfaces and methods of making will be or become apparent to one with skill in the art upon examination of the following drawings and detailed description. It is intended that all such additional systems, methods, features, and advantages be included within this description, be within the scope of the present disclosure, and be protected by the accompanying claims.

Although any methods and materials similar or equivalent to those described herein can also be used in the practice or testing of the present disclosure, the preferred methods and materials are now described. Functions or constructions well-known in the art may not be described in detail for brevity and/or clarity. Aspects of the present disclosure will employ, unless otherwise indicated, techniques of nanotechnology, organic chemistry, material science and engineering and the like, which are within the skill of the art. Such techniques are explained fully in the literature.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. Furthermore, any incorporation by reference of patents and patent applications to which the instant application claims priority is not intended to extend to any lexicographical definitions in the patents and patent applications so incorporated and should not be read as limiting the accompanying claims.

The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and the range less than ‘y’. The range can also be expressed as an upper limit e.g., ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some aspects, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in aspects of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

### Solid-Infused Surfaces

Solid-infused surfaces and articles having solid-infused surfaces are provided. The solid-infused surfaces can provide surfaces that having one or more improved properties including improved non-wettability or liquid shedding behavior, improved anti-fouling properties, improved condensation heat transfer, improved ease of manufacturing, and/or improved durability.

The solid-infused surface can be made on any substrate which has or can be made to have a suitable roughened surface and is capable of being partially coated with the low surface-energy polymer. In some aspects, the article is a pipe or other conduit and the solid-infused surface is on an inner or outer surface of the pipe or conduit. For example, the article can be a radiator, cooling coil, refrigeration coil, or similar component. The article can be an oil pipe, line, container, or the inner our outer surface of an engine or component therefore.

In some aspects, the article is a solar panel or other electronic component, optical component, or piece of equipment that is meant to operate in environments prone to fouling such as in a marine environment or the like. The article can be an industrial tank, vat, or the like. The article can include any container, pipeline, nozzle, valve, conduit, vessel, bottle, mold, die, chute, bowl, tub, bin, cap for a bottle or container, tube, or a combination thereof.

The solid-infused surface can have an asymptotic fouling resistance that is reduced compared to the untreated or smooth surface. For example, the solid-infused surface can have an asymptotic fouling resistance that is reduced by at least 8%, at least 10%, at least 15%, or at least 20% when compared to the asymptotic fouling resistance of a smooth untreated surface of the otherwise same substrate when measured under the otherwise same conditions.

In some aspects, the solid-infused surface exhibits a reduction in a foulant accumulation e.g. a reduction of at least 10%, at least 20%, at least 30%, or at least 40% when compared to a foulant accumulation for a smooth untreated surface of the otherwise same substrate when measured under the same conditions.

The foulant can include any mineral foulant, biological foulant, or other form of foulant dependent upon the application. In some aspects, the foulant is selected from sulfates, nitrates, phosphates, calcium, lime, and a combination thereof.

### Substrates Having a Roughened Surface

The solid-infused surfaces include a substrate having a roughened surface having multi-scale surface roughness and a plurality of substrate asperities. The roughened surface having multi-scale roughness contributes to the non-wetting behavior of the surface and the large micron-scale roughness allows for coating with the low surface-energy polymer while leaving a fraction of the substrate asperities exposed on the solid-infused surface.

Multi-scale roughness can be characterized as described herein by measuring the fractal dimension (D), determined from a Fast Fourier Transform (FFT) based power spectrum of the surface profile. Where a smooth surface may have a fractal dimension near 1, the multi-scale roughened surfaces can have a fractal dimension of about 1.1 to about 5, about 1.1. to about 2.5, about 1.3 to about 2.5, about 1.5 to about 2.5, about 1.7 to about 2.5, or about 2.0 to about 2.5.

The micron-scale roughness can be characterized by a maximum peak to valley height as measured by scanning electron microscope of about 1 μm to about 100 μm, about 1 μm to about 50 μm, about 5 μm to about 50 μm, about 5 μm to about 25 μm, or about 5 μm to about 15 μm. The micron-scale roughness can be characterized by an average roughness of about 1 μm to about 50 μm, about 1 μm to about 25 μm, about 2 μm to about 25 μm, about 2 μm to about 20 μm, about 2 μm to about 12 μm, or about 3 μm to about 10 μm. The micron-scale roughness can be characterized by a root mean square roughness of about 1 μm to about 50 μm, about 1 μm to about 25 μm, about 2 μm to about 25 μm, about 2 μm to about 20 μm, about 2 μm to about 12 μm, or about 3 μm to about 10 μm.

Suitable substrates can include any substrate that has or can be fabricated to have the required micron-scale and multi-scale roughness. In some aspects, the substrate is copper. In some instances the substrate is selected from the group consisting of copper, tin, iron, zinc, manganese, carbon, silicon, tin, chromium, phosphorous, alloys thereof, and combinations thereof. The substrate can include brass, bronze, monel, steel, stainless steel, Inconel, or a combination thereof.

### Low Surface-Energy Polymer

The roughened surface is partially coated with a low surface-energy polymer forming the solid-infused surface having a fraction of the substrate asperities exposed on the solid-infused surface. The exposed asperities can provide higher surface energy sites for nucleation to assist with rapid dropwise condensation while the low surface-energy polymer provides for rapid and facile removal of the fouling material from the surface.

In some aspects, the faction of exposed asperities can be characterized by a solid area fraction of the exposed substrate asperities on the solid-infused surface determined by measuring the ratio of the 2-dimensional surface area of the exposed asperities to the total surface area in a two-dimensional projected surface area determined, for example, in an SEM image of the solid-infused surface. In some instances the solid area fraction of the exposed substrate asperities on the solid-infused surface is about 0.01 to about 0.30, about 0.01 to about 0.25, about 0.01 to about 0.20, about 0.02 to about 0.20, about 0.03 to about 0.20, about 0.03 to about 0.15, about 0.04 to about 0.15.

The coating includes a low surface-energy polymer. The low surface-energy polymer can have a water contact angle of about 94° to about 140°, about 100° C. to about 140° C., about 105° C. to about 140° C., about 105° C. to about 135° C., or about 110° C. to about 135° C. In some aspects, the low-surface energy polymer is selected from the group consisting of nylon, polybutadiene, polyethylene (PE), polychlorotrifluoroethylene (PCTFE), polypropylene (PP), polydimethylsiloxane (PDMS), poly t-butyl methacrylate (PtBMA), fluorinated ethylene propylene (FEP), hexatriacontane, paraffin, polytetrafluoroethylene (PTFE), poly(hexafluoropropylene), polyisobutylene (PIB, butyl rubber), silicone, polyester, polyester, polyurethane, copolymers, thereof, and blends thereof. The low surface-energy polymer can include a Gentoo® polymer.

The polymer can include any of those listed below.

| Polymer | Water contact angle (°) |
|---|---|
| Nylon 10, 10 | 94 |
| Polybutadiene | 96 |
| Polyethylene (PE) | 96 |
| Polychlorotrifluoroethylene (PCTFE) | 99.3 |
| Polypropylene (PP) | 102.1 |
| Polydimethylsiloxane (PDMS) | 107.2 |
| Poly t-butyl methacrylate (PtBMA) | 108.1 |
| Fluorinated ethylene propylene (FEP) | 108.5 |
| Hexatriacontane | 108.5 |
| Paraffin | 108.9 |
| Polytetrafluoroethylene (PTFE) | 109.2 |
| Poly(hexafluoropropylene) | 112 |
| Polyisobutylene (PIB, butyl rubber) | 112.1 |
| Gentoo | 120-130 |

### Methods of Making Solid-Infused Surfaces

Various methods are provided for making the solid-infused surfaces described herein. The methods include providing or otherwise forming a roughened surface on a surface of the substrate. The roughened surface can have micron-scale roughness and/or multi-scale roughness as described above. The methods can be selected based on the specific substrate and the desired roughness or the desired fractal dimension. The roughening step can include one or more of chemical etching, electrodeposition, lithography, oxidation via electrodeposition, nanoparticle composite coating, thermal spraying, plasma spraying, high velocity oxygen fuel (HOVF) coating, and combinations thereof.

Chemical etching can include contacting a surface of the substrate with an etching composition or etching fluid. Such an etching composition can include a strong acid such as hydrochloric acid, hydrofluoric acid, or the like. The etching composition can include hydrogen peroxide or another peroxide.

Electrodeposition methods are known in the art. Methods of forming a roughened surface can include depositing a metal or alloy on a surface of the substrate. The methods can include deposition a material that is different from the material of the substrate or a material that is the same or similar to the substrate but provides the desired surface roughness.

Lithography techniques can include common techniques such as UV lithography, laser-micromachining, electron-beam lithography, soft-lithography, X-ray lithography, plasma etching etc. The main advantage of the lithographic techniques is the creation of well-defined patterned structures with controllable geometrical characteristics.

The methods can include any of those listed below.

| Fabrication method | Roughness features |
|---|---|
| Chemical etching | Multiscale Micro-nano |
| Electrodeposition | Multiscale Micro-nano |
| Lithography | Monoscale micro or nano |
| Oxidation via electrodeposition | Nanostructured copper |
| Nanoparticle composite coating; | Microaggregates formed from |
| thermal spraying | nanoscale particles |
| Plasma spraying | Microstrucutres from |
| | nanostructured feedstock |
| High Velocity Oxygen Fuel | Composite micro-nano |
| (HOVF) coating | structures |

The roughened surface can be partially coated with a low surface-energy polymer to leave a fraction of the substrate asperities exposed on the solid-infused surface. The methods can include curing or casting a polymer or polymer composition onto the roughened surface. The curing a one-component or a two-component polymer system using one or more of light, heat, a chemical activator, or a combination thereof. The methods can include spraying a polymer solution onto the roughened surface and/or dipping the roughened surface into a polymer solution. The methods can include spinning the surface to thin the polymer coating on the roughened surface before drying or curing. Depending on the polymer system and any curing agents used, the polymers can be cured with the application of light, heat, a chemical curing agent, or any combination thereof. Those skilled in the art, upon reading this disclosure, will understand many ways of coating the portion of the substrate surface.

### Aspects of the Disclosure

The present disclosure will be better understood upon reading the following numbered aspects, which should not be confused with the claims. In some instance, the aspects below may be combined with one or more additional aspects or with other aspects described elsewhere in the disclosure and accompanying examples. All such variations and combinations are intended to be covered by the instant disclosure.
Aspect 1. An article comprising a solid-infused surface, the solid-infused surface comprising (a) a substrate comprising a roughened surface having multi-scale surface roughness and a plurality of substrate asperities, and (b) a low surface-energy polymer coating a portion of the roughened surface forming the solid-infused surface having a fraction of the substrate asperities exposed on the solid-infused surface.
Aspect 2. The article according to any one of Aspects 1-19, wherein the roughened surface has a maximum peak to valley height as measured by scanning electron microscope of about 1 μm to about 100 μm, about 1 μm to about 50 μm, about 5 μm to about 50 μm, about 5 μm to about 25 μm, or about 5 μm to about 15 μm.
Aspect 3. The article according to any one of Aspects 1-19, wherein the roughened surface has an average roughness of about 1 μm to about 50 μm, about 1 μm to about 25 μm, about 2 μm to about 25 μm, about 2 μm to about 20 μm, about 2 μm to about 12 μm, or about 3 μm to about 10 μm.
Aspect 4. The article according to any one of Aspects 1-19, wherein the roughened surface has a root mean square roughness of about 1 μm to about 50 μm, about 1 μm to about 25 μm, about 2 μm to about 25 μm, about 2 μm to about 20 μm, about 2 μm to about 12 μm, or about 3 μm to about 10 μm.
Aspect 5. The article according to any one of Aspects 1-19, wherein the roughened surface has a fractal dimension of about 1.1 to about 5, about 1.1. to about 2.5, about 1.3 to about 2.5, about 1.5 to about 2.5, about 1.7 to about 2.5, or about 2.0 to about 2.5.
Aspect 6. The article according to any one of Aspects 1-19, wherein a solid area fraction of the exposed substrate asperities on the solid-infused surface is about 0.01 to about 0.30, about 0.01 to about 0.25, about 0.01 to about 0.20, about 0.02 to about 0.20, about 0.03 to about 0.20, about 0.03 to about 0.15, about 0.04 to about 0.15.
Aspect 7. The article according to any one of Aspects 1-19, wherein the substrate comprises a copper substrate.
Aspect 8. The article according to any one of Aspects 1-19, wherein the substrate comprises a substrate selected from the group consisting of copper, tin, iron, zinc, manganese, carbon, silicon, tin, chromium, phosphorous, alloys thereof, and combinations thereof.
Aspect 9. The article according to any one of Aspects 1-19, wherein the substrate comprises brass, bronze, monel, steel, stainless steel, Inconel, or a combination thereof.
Aspect 10. The article according to any one of Aspects 1-19, wherein the low surface-energy polymer has a water contact angle of about 94° to about 140°, about 100° C. to about 140° C., about 105° C. to about 140° C., about 105° C. to about 135° C., or about 110° C. to about 135° C.
Aspect 11. The article according to any one of Aspects 1-19, wherein the low-surface energy polymer is selected from the group consisting of nylon, polybutadiene, polyethylene (PE), polychlorotrifluoroethylene (PCTFE), polypropylene (PP), polydimethylsiloxane (PDMS), poly t-butyl methacrylate (PtBMA), fluorinated ethylene propylene (FEP), hexatriacontane, paraffin, polytetrafluoroethylene (PTFE), poly(hexafluoropropylene), polyisobutylene (PIB, butyl rubber), silicone, polyester, polyester, polyurethane, copolymers, thereof, and blends thereof.
Aspect 12. The article according to any one of Aspects 1-19, wherein the low surface-energy polymer comprises a Gentoo® polymer.
Aspect 13. The article according to any one of Aspects 1-19, wherein the solid-infused surface has an asymptotic fouling resistance that is reduced by at least 8%, at least 10%, at least 15%, or at least 20% when compared to the asymptotic fouling resistance of a smooth untreated surface of the otherwise same substrate when measured under the otherwise same conditions.
Aspect 14. The article according to any one of Aspects 1-19, wherein the solid-infused surface exhibits a reduction in a foulant accumulation of at least 10%, at least 20%, at least 30%, or at least 40% when compared to a foulant accumulation for a smooth untreated surface of the otherwise same substrate when measured under the same conditions.
Aspect 15. The article according to any one of Aspects 1-19, wherein the foulant is selected from sulfates, nitrates, phosphates, calcium, lime, and a combination thereof.
Aspect 16. The article according to any one of Aspects 1-19, wherein the article is an inner or outer surface of a pipe or conduit.
Aspect 17. The article according to any one of Aspects 1-19, wherein the pipe or conduit is a part of a radiator.
Aspect 18. The article according to any one of Aspects 1-19, wherein the article is a solar panel or a component thereof.
Aspect 19. The article according to any one of Aspects 1-19, wherein the article is selected from the group consisting of a container, a pipeline, nozzle, valve, a conduit, a vessel, a bottle, a mold, a die, a chute, a bowl, a tub, a bin, a cap for a bottle or container, a tube, and a combination thereof.
Aspect 20. A method of making a solid-infused surface on an article, the method comprising (a) roughening a surface of a substrate to produce a roughened surface having multi-scale surface roughness and a plurality of substrate asperities, and (b) coating a portion of the roughened surface with a low surface-energy polymer to form the solid-infused surface having a fraction of the substrate asperities exposed on the solid-infused surface.
Aspect 21. The method according to any one of Aspects 20-40, wherein the roughening step comprises one or more of chemical etching, electrodeposition, lithography, oxidation via electrodeposition, nanoparticle composite coating, thermal spraying, plasma spraying, high velocity oxygen fuel (HOVF) coating, and combinations thereof.
Aspect 22. The method according to any one of Aspects 20-40, wherein the coating step comprises curing a one-component or a two-component polymer system using one or more of light, heat, a chemical activator, or a combination thereof.
Aspect 23. The method according to any one of Aspects 20-40, wherein the roughened surface has a maximum peak to valley height as measured by scanning electron microscope of about 1 μm to about 100 μm, about 1 μm to about 50 μm, about 5 μm to about 50 μm, about 5 μm to about 25 μm, or about 5 μm to about 15 μm.
Aspect 24. The method according to any one of Aspects 20-40, wherein the roughened surface has an average roughness of about 1 μm to about 50 μm, about 1 μm to about 25 μm, about 2 μm to about 25 μm, about 2 μm to about 20 μm, about 2 μm to about 12 μm, or about 3 μm to about 10 μm.
Aspect 25. The method according to any one of Aspects 20-40, wherein the roughened surface has a root mean square roughness of about 1 μm to about 50 μm, about 1 μm to about 25 μm, about 2 μm to about 25 μm, about 2 μm to about 20 μm, about 2 μm to about 12 μm, or about 3 μm to about 10 μm.
Aspect 26. The method according to any one of Aspects 20-40, wherein the roughened surface has a fractal dimension of about 1.1 to about 5, about 1.1. to about 2.5, about 1.3 to about 2.5, about 1.5 to about 2.5, about 1.7 to about 2.5, or about 2.0 to about 2.5.
Aspect 27. The method according to any one of Aspects 20-40, wherein a solid area fraction of the exposed substrate asperities on the solid-infused surface is about 0.01 to about 0.30, about 0.01 to about 0.25, about 0.01 to about 0.20, about 0.02 to about 0.20, about 0.03 to about 0.20, about 0.03 to about 0.15, about 0.04 to about 0.15.
Aspect 28. The method according to any one of Aspects 20-40, wherein the substrate comprises a copper substrate.
Aspect 29. The method according to any one of Aspects 20-40, wherein the substrate comprises a substrate selected from the group consisting of copper, tin, iron, zinc, manganese, carbon, silicon, tin, chromium, phosphorous, alloys thereof, and combinations thereof.
Aspect 30. The method according to any one of Aspects 20-40, wherein the substrate comprises brass, bronze, monel, steel, stainless steel, Inconel, or a combination thereof.
Aspect 31. The method according to any one of Aspects 20-40, wherein the low surface-energy polymer has a water contact angle of about 94° to about 140°, about 100° C. to about 140° C., about 105° C. to about 140° C., about 105° C. to about 135° C., or about 110° C. to about 135° C.
Aspect 32. The method according to any one of Aspects 20-40, wherein the low-surface energy polymer is selected from the group consisting of nylon, polybutadiene, polyethylene (PE), polychlorotrifluoroethylene (PCTFE), polypropylene (PP), polydimethylsiloxane (PDMS), poly t-butyl methacrylate (PtBMA), fluorinated ethylene propylene (FEP), hexatriacontane, paraffin, polytetrafluoroethylene (PTFE), poly(hexafluoropropylene), polyisobutylene (PIB, butyl rubber), silicone, polyester, polyester, polyurethane, copolymers, thereof, and blends thereof.
Aspect 33. The method according to any one of Aspects 20-40, wherein the low surface-energy polymer comprises a Gentoo® polymer.
Aspect 34. The method according to any one of Aspects 20-40, wherein the solid-infused surface has an asymptotic fouling resistance that is reduced by at least 8%, at least 10%, at least 15%, or at least 20% when compared to the asymptotic fouling resistance of a smooth untreated surface of the otherwise same substrate when measured under the otherwise same conditions.
Aspect 35. The method according to any one of Aspects 20-40, wherein the solid-infused surface exhibits a reduction in a foulant accumulation of at least 10%, at least 20%, at least 30%, or at least 40% when compared to a foulant accumulation for a smooth untreated surface of the otherwise same substrate when measured under the same conditions.
Aspect 36. The method according to any one of Aspects 20-40, wherein the foulant is selected from sulfates, nitrates, phosphates, calcium, lime, and a combination thereof.
Aspect 37. The method according to any one of Aspects 20-40, wherein the article is an inner or outer surface of a pipe or conduit.
Aspect 38. The method according to any one of Aspects 20-40, wherein the pipe or conduit is a part of a radiator.
Aspect 39. The method according to any one of Aspects 20-40, wherein the article is a solar panel or a component thereof.
Aspect 40. The method according to any one of Aspects 20-40, wherein the article is selected from the group consisting of a container, a pipeline, nozzle, valve, a conduit, a vessel, a bottle, a mold, a die, a chute, a bowl, a tub, a bin, a cap for a bottle or container, a tube, and a combination thereof.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Example 1: Solid-Infused Surfaces for High Efficiency Condensation

This example demonstrates solid-infused surfaces that are durable and can be used for condensation of steam that combine the heat transfer characteristics of metal while promoting dropwise condensation. The solid-infused surfaces overcome the issues of durability and scalability associates with other hybrid surface approaches.

### Method Summary

### Solid-Infused Surface (SIS) Fabrication:

First, a 0.95-cm diameter 122 copper tube (McMaster-Carr) was cut to 20-cm length and both ends were capped to prevent modification of the smooth, inner surface. Next, for the texturing step, the tube was textured via chemical etching in a 1:1 mixture of 12M hydrochloric acid (Fisher Scientific) and 3% hydrogen peroxide (CVS Pharmacy) for 20 minutes. The resulting, microtextured tube was cleaned thoroughly with deionized water and a soft-bristled brush to remove residue, then rinsed with methanol (McMaster-Carr) and allowed to dry. Gentoo was used as the infused solid for the coating step. Gentoo is a two-part, hydrophobic, polymer coating. To functionalize a test section, Gentoo parts A and B were first mixed in a 1:1 ratio by weight and stirred for 120 minutes at room temperature. Next, the test section was capped on one end, fitted into a handheld drill, and then dipped into the Gentoo mixture. After removal, the test section was immediately spun at approximately 1700 rpm while a flexible, nitrile membrane was lightly pressed against the test section surface to thin the Gentoo coating and create a macroscopically smooth, hybrid copper-polymer surface. After air drying for approximately 10 minutes, the test section was cured at 90° C. for one hour. Micrographs of completed surfaces were obtained with a FEI Quanta FEG environmental scanning electron microscope (ESEM) and contact angle measurements were made to within ±2° using a rame-hart Model 190 optical goniometer.

### Steam Condensation Experimental Procedure:

The steam condensation experimental apparatus as described in Stoddard, et al. (Ref 21) was used for all experiments in this study. Prior to experimentation, the hotwell water temperature was heated to 40° C. and put under vacuum, allowing it to boil vigorously for approximately 30 minutes to remove non-condensable gases from the water and chamber. For each subsequent experiment, the hotwell water was maintained at 40° C. A test section was mounted in the apparatus and pressure was reduced to approximately 7.4 kPa, allowing the hotwell water to boil. As the chamber temperature and pressure were held constant, coolant temperature through the test section was adjusted and allowed to reach steady state at desired conditions for experimental measurements. Steady state at each ΔT_{LM} was determined by reference to test section inlet temperature stabilizing within 0.2° C. of target inlet temperature for at least one minute. Coolant water temperature could be adjusted from 10° C. to 40° C. Coolant water temperature was started low and increased during the course of a typical experiment in order to take measurements across a 20° C. range of subcooling.

### Data Reduction:

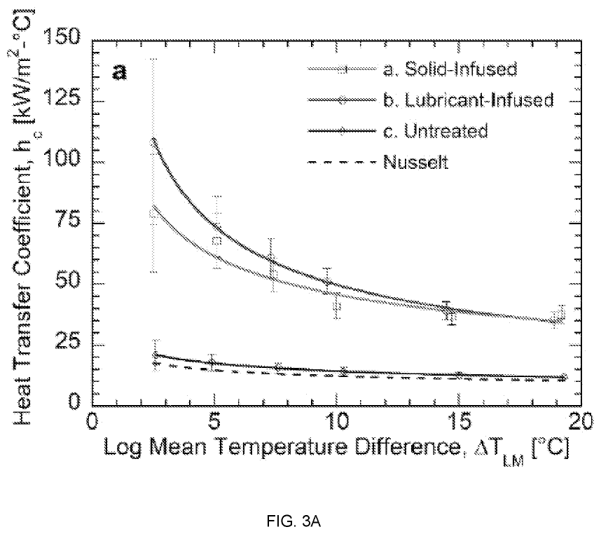

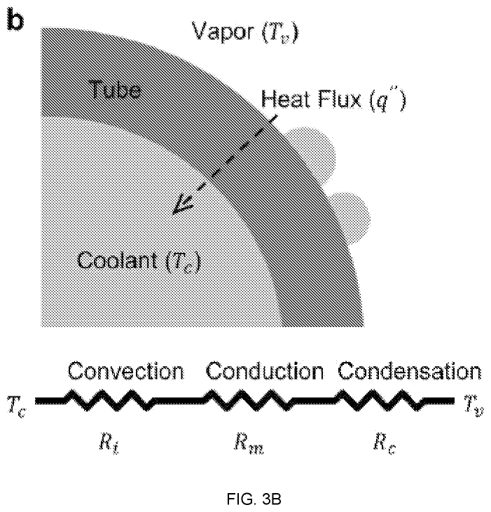

The total heat transfer rate (\dot{q}) was computed based on experimentally measured coolant flow conditions, as given by:

$$\dot{q} = ρ \dot{V} {c}_{p} ( {T}_{out} - {T}_{i n} )$$

where ρ, \dot{V}′, cₚ, Tᵢₙ, and Tₒᵤₜ are the density, flow rate, specific heat capacity, inlet temperature and outlet temperature of the coolant water, respectively. The total resistance to heat transfer Rₜ (FIG. 3B) was calculated by dividing the logarithmic mean temperature difference (ΔT_{LM}) by q, as given by:

$${R}_{t} = \frac{Δ {T}_{LM}}{\dot{q}}$$

$$Δ {T}_{LM} = \frac{( {T}_{v} - {T}_{out} ) - ( {T}_{v} - {T}_{i n} )}{ln \frac{{T}_{v} - {T}_{out}}{{T}_{v} - {T}_{i n}}}$$

where Tᵥ is the vapor temperature inside the vacuum condensation chamber. The Petukhov correlation (Ref 25) factor for a smooth pipe coupled with the Gnielinski convection correlation (Ref 25) for turbulent flow in circular tubes were used to calculate the internal convection heat transfer coefficient (hᵢ). Next, hᵢ was used to calculate the internal convection resistance to heat transfer (Rᵢ), while the thermal conductivity of copper (kₘ) was assumed constant at 0.385 kW/m-° C. to calculate the conductive heat transfer resistance of the condenser tube material (Rₘ). The external thermal resistance to condensation heat transfer (R_{c}) was then calculated by subtracting Rᵢ and Rₘ from Rₜ and converted to an external condensation heat transfer coefficient (h_{c}).

### Experimental Uncertainty Analysis:

Standard analysis techniques for calculating statistical and instrument uncertainty (Refs. 34-35) were used to determine 95% confidence interval for all experimentally measured data and algebraic uncertainty propagation was used for all reduced heat transfer coefficient and effectiveness calculations.

### DISCUSSION

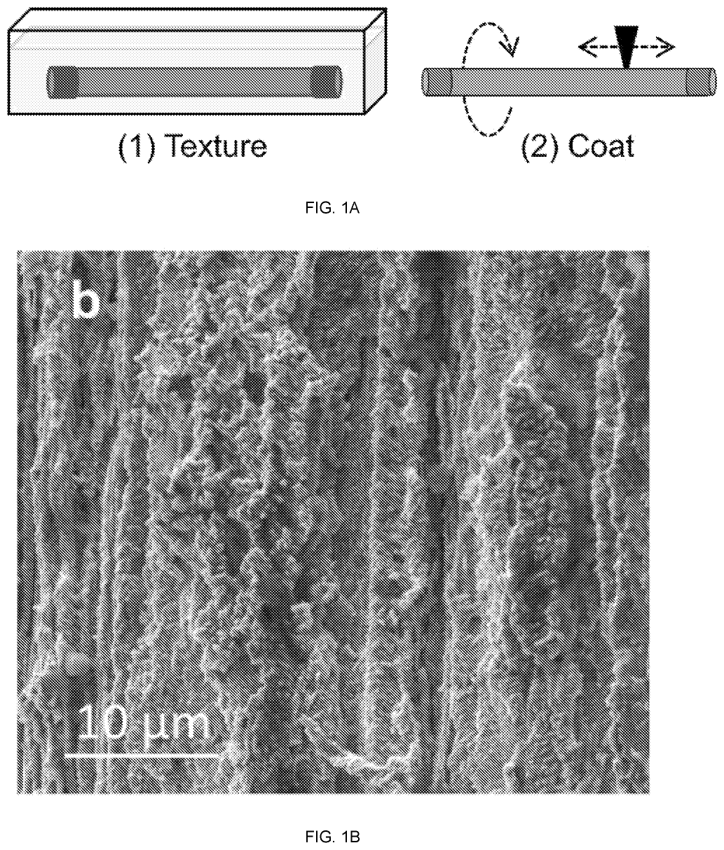

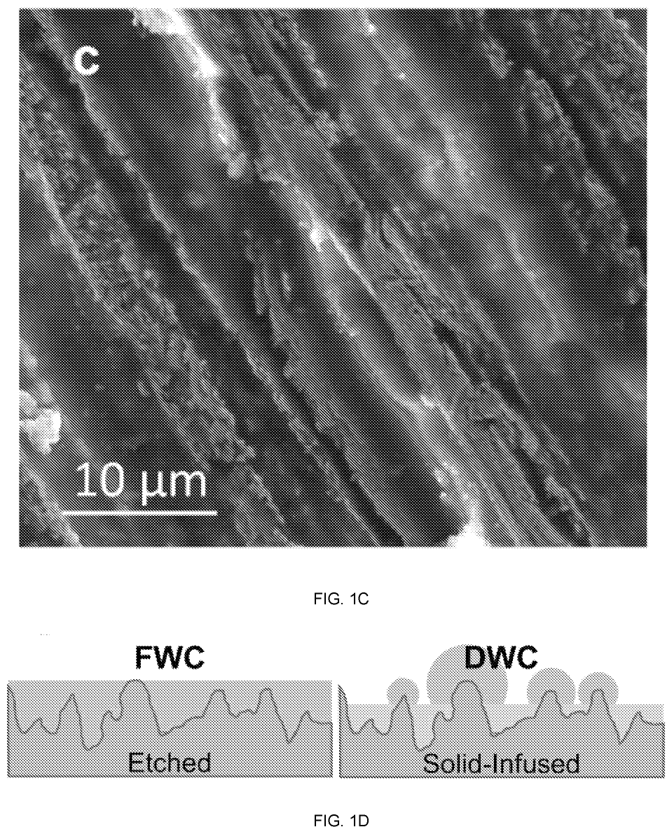

Motivated by the need to improve condensation technologies, this example demonstrates solid-infused surfaces (SISs) that promote and sustain DWC while eliminating the aforementioned drawbacks of SHSs and LISs. We fabricated SISs via an easily scalable, two-step process as shown in FIG. 1A and described in the methods section above. The texturing step produced a multiscale, roughened copper substrate (FIG. 1B) with asperity height of ˜6 μm. The coating step filled the concave portions of the asperities with polymer while leaving the asperity peaks exposed (FIG. 1C). The resulting solid-infused surface created a composite interface of high thermal conductivity copper and DWC inducing functionalizing agent with excellent non-wetting characteristics—apparent contact angle (θ_{c}) of 115.2° and roll off angle (θᵣ)≤5°—that promoted DWC as depicted in FIG. 1D.

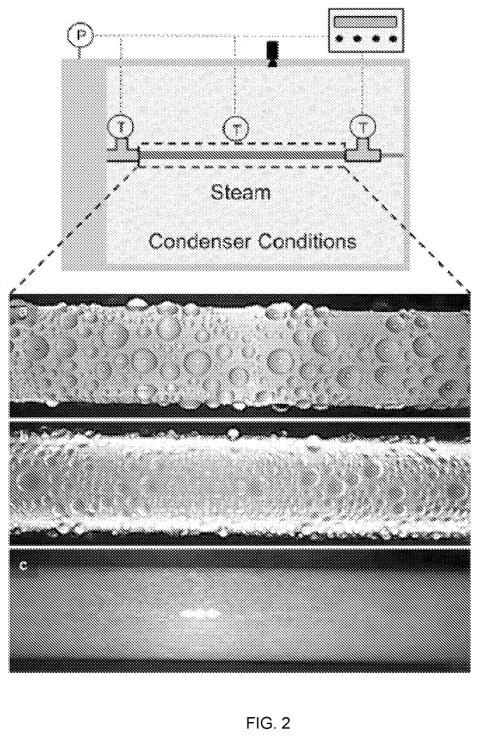

The SISs were tested under negligible non-condensable gas condensation conditions with vapor temperature (Tᵥ) of 40° C., closely modeling a power plant condenser environment. Surface subcooling was controlled in the range 2.5-20° C. as measured using logarithmic mean temperature difference (ΔT_{LM}) (Ref. 25) in order to encompass typical steam condenser operating range 6-11° C. (Ref 26) Images of condensation on SIS, LIS, and untreated tubes are shown in FIG. 2. The SIS tube (FIG. 2, top) showed vigorous and continuous droplet nucleation and shedding. The hybrid copper-polymer surface formed an interface between the bulk copper tube and the condensing environment. The copper peaks protruding through the functionalizing agent acted as nucleation points for condensation to begin. Once droplets grew to sufficient size, the majority of their footprint was in contact with the cured functionalizing agent surrounding the nucleation point, causing continuous droplet shedding and condensate nucleation.

Maximum droplet diameter was approximately 2.7 mm which equates to the capillary length (l_{c}) of liquid water at 40° C. as given by the relation l_{c}=\sqrt{σ/ρg}, where σ and ρ are the surface tension and density of water and g is the acceleration of gravity. Since droplet size remained less than or equal to l_{c} it indicates that the gravitational force pulling condensate from the surface remained dominant over surface forces acting on the droplet (Ref. 27) resulting in sustained DWC.

As benchmarks for the state of condensation science, LIS and untreated tubes were also tested for comparison with the SIS. LISs represent the high-end of reliably achievable condensation heat transfer coefficients on non-wetting surfaces. Thus, we fabricated an LIS by texturing a copper tube via the same chemical etching procedure described earlier, then functionalized it using n-Hexadecyl Mercaptan and infused the asperities with Krytox GPL 104. (Ref. 21) FIG. 2, middle shows small-diameter DWC on the LIS that is similar in quality to that shown on the SIS. Additionally, the droplet shedding rate was qualitatively comparable to the SIS. On the low end of the condensation spectrum, FWC represents the default planning consideration for heat transfer. For direct comparison of FWC to the DWC produced on SIS and LIS tubes, we tested a textured but otherwise untreated tube for our low-end benchmark, clearly obtaining FWC on the untreated surface (FIG. 2, bottom).

Quantitatively, the distinctive condensation modes shown in FIG. 2 translated to substantially different values of heat transfer coefficient for the three surfaces, as shown in FIG. 3A. The DWC observed on both SIS and LIS tubes produced condensation heat transfer coefficients (h_{c}) roughly 3-times higher than FWC on the untreated tube at the high-ΔT_{LM} range. At low-ΔT_{LM} both SIS and LIS treated tubes showed exceptional heat transfer performance with h_{c} of SIS achieving a fourfold improvement over FWC and LIS achieving a fivefold improvement. Additionally, the measured h_{c}! values are compared with the classic Nusselt correlation (Ref 28) for FWC heat transfer coefficient (h_{N}y) on tubes:

$${h}_{Nu} = {0.729 [ \frac{g {ρ}_{l} ( {ρ}_{l} - {ρ}_{v} ) {k}_{l}^{3} {h}_{fg}}{{μ}_{l} {D}_{o} Δ {T}_{LM}} ]}^{\frac{1}{4}}$$

where ρₜ, ρᵥ, kₗ, h_{fg}, and μₗ represent liquid density, vapor density, thermal conductivity, latent heat of vaporization, and viscosity of water. The h_{c} values on the untreated tube showed close agreement with h_{Nμ}.

Condensation heat transfer coefficient (h_{c}) can vary from zero to infinity, which does not proportionally scale to the actual improvements that a modified condensing surface provides to a heat transfer circuit (FIG. 3B). Furthermore, the data reduction techniques used in the literature (Refs. 16, 29, and 30) and in this example can lead to extremely large values and uncertainty bands for h_{c}, particularly at low ΔT_{LM}. Here, the data was analyzed using heat transfer effectiveness to demonstrate contextually the performance enhancement a solid-infused surface (or any DWC-promoting surface) can be reasonably expected to provide in a condenser. Effectiveness (ε) is the ratio of the real heat flux (q″) to the maximum possible heat flux (q″ₘₐₓ) of a heat exchanger (Ref 31), and is commonly used in heat exchanger design and optimization (Refs. 32, 33). For a fixed coolant flow rate and condenser material setup, such as the experimental apparatus in this study, convective heat transfer resistance on the inside of the condenser tube (R_{L}) and conductive heat transfer resistance of the condenser tube material (Rₘ) are known (FIG. 3B). This allows calculation of a maximum attainable heat flux (q″ₘₐₓ) through the external surface of the system by assuming a perfect condensing surface (h_{c}→∞,R_{c}=0). This q″ₘₐₓ can then be compared with the experimentally measured value of heat flux (q″) to determine heat transfer effectiveness (ε):

$$ε = \frac{{q}^{″}}{{{q}^{″}}_{m a x}} = \frac{{R}_{i} + {R}_{m}}{{R}_{i} + {R}_{m} + {R}_{c}}$$

where R_{c} is condensation heat transfer resistance. Applying this approach to the experimental results of the SIS, LIS, and untreated tubes reduces the apparent performance gap between SIS and LIS in terms of h_{c} at low-ΔT_{LM}, providing a contextual reference for the potential impact of each surface on a condenser as a whole. The values of Rᵢ and Rₘ for the experimental apparatus in this study were 31.6° C./kW and 0.46° C./kW; however, the relationship above for the heat transfer effectiveness holds for any heat exchanger when using application-specific values of Rᵢ and Rₘ, making the following observations applicable in a broad context.

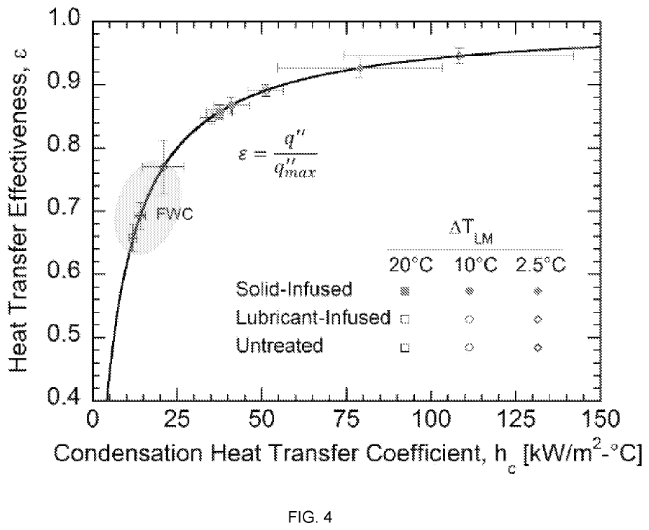

As shown in FIG. 4, heat transfer effectiveness (ε) improved from 0.66 to 0.77 for the untreated tube—an 11-percentage point increase—as h_{c} went from 12.0 kW/m²-° C. at ΔT_{LM}=20° C. to 20.9 kW/m²-° C. at ΔT_{LM}=2.5° C. This shows two important benefits of analyzing data using heat transfer effectiveness. First, condensing surfaces become more efficient at lower ΔT_{LM}, transferring a higher percentage of maximum potential heat flux (q″ₘₐₓ) into the tube wall. This is due to the inverse relationship between degree of subcooling and h_{c} demonstrated in the Nusselt correlation (above). Second, the shape of the ε-vs-h_{c} curve in the FWC zone characterized by h_{c}≲20 kW/m²° C., shows condensation is the limiting thermal resistance in the overall heat transfer circuit. Thus, any potential increase in heat transfer coefficient (h_{c}) in this zone has a dramatic impact on the overall operation of the heat exchanger. This can lead to incorrect suppositions that fantastic improvements in h_{c} will always lead to similarly large improvements in system operation.

As shown by the remainder of the ε-vs-h_{c} curve, however, this supposition is quickly challenged as ε becomes asymptotic in the h_{c} range that is only achievable via DWC. In this segment of the curve, the SIS and LIS results show ε values in the range 0.85-0.94. At ΔT_{LM}=20° C., the SIS shows ε of 0.86 while LIS shows ε of 0.85—a difference of only 1 percentage point despite a 7% difference in h_{c} (37.5 kW/m²-° C. for SIS and 35.1 kW/m²-° C. for LIS). Likewise, at ΔT_{LM}=10° C., the SIS shows ε of 0.87 and LIS shows ε of 0.89. This 2-percentage point difference stems from a 25% difference in h_{c} of 41.0 kW/m²-° C. for SIS and 51.2 kW/m²-° C. for LIS. For both ΔT_{LM} of 20° C. and 10° C., ε is nearly linear with respect to h_{c}, indicating that the thermal resistance due to forced convection on the inside of the condenser tube (R_{L}) is roughly equivalent to R_{c}. Thus, large differences in h_{c} have a smaller impact on overall system performance. Finally, at ΔT_{LM}=2.5° C., the 38% difference in h_{c} between SIS (79.0 kW/m²-° C.) and LIS (108.9 kW/m²-° C.) translates to only a 1-percentage point difference in ε (0.93 for SIS and 0.94 for LIS). In this region

of the ε-vs-h_{c} curve, R_{L} is the limiting thermal resistance and ε is asymptotic with respect to h_{c}. Here, substantial increases in h_{c} have only diminishing additional impact on holistic system performance. Thus, the overall effectiveness of SIS tubes is statistically equivalent to LIS tubes as ε values fall within the ±0.02 error band for all ε estimates, regardless of ΔT_{LM}. Importantly, due to the nature of the solid-infusion as compared with lubricant-infusion, SISs are not subject to the drawbacks associated with LISs; there is no concern of lubricant depletion, cloaking or flooding, thus allowing for sustained DWC.

In conclusion, this example demonstrates that SISs is a facile surface modification technique for promoting sustained dropwise condensation of steam. They achieve condensation heat transfer effectiveness results on par with LISs and exceed FWC heat transfer coefficients by a factor of three to four. Additionally, they do not rely on esoteric, often irreproducible, condensation modes such as jumping-droplet condensation and they overcome the understood drawbacks of LISs, such as droplet cloaking within the infused lubricant and potential lubricant depletion leading to pinning of condensate. Further, SIS fabrication is easily scalable and does not rely on sensitive nanotextured surfaces. The SISs in this study were fabricated using copper substrate and a polymer coating; the texturing and coating steps of the fabrication process can be readily used on any roughened substrate infused with a non-wetting, curing agent. The fundamental innovation is the hybrid interface of conductive metal that serves as nucleation points for condensate and non-wetting solid agent in asperity valleys to promote DWC, making the technique scalable to most condensation applications.

### REFERENCES FOR EXAMPLE 1

1. Murrant, D., Quinn, A. & Chapman, L. The water-energy nexus: Future water resource availability and its implications on UK thermal power generation. Water Environ. J. 29, 307-319 (2015).
2. Brown, T. C., Mahat, V. & Ramirez, J. A. Adaptation to Future Water Shortages in the United States Caused by Population Growth and Climate Change. Earth's Futur. 7, 219-234 (2019).
3. Liu, S. et al. Global river water warming due to climate change and anthropogenic heat emission. Glob. Planet. Change 193, 103289 (2020).
4. Nithyanandam, K., Shoaei, P. & Pitchumani, R. Technoeconomic analysis of thermoelectric power plant condensers with nonwetting surfaces. Energy 227, 120450 (2021).
5. Cooling Power Plants. World Nuclear Association
6. Othmer, D. F. The Condensation of Steam. Ind. Eng. Chem. 21, 576-583 (1929).
7. Tanasawa, I. Advances in Condensation Heat Transfer. Adv. Heat Transf 21, 55-139 (1991).
8. Tanner, D. W., Potter, C. J., Pope, D. & West, D. Heat transfer in dropwise condensation-Part I The effects of heat flux, steam velocity and non-condensable gas concentration. Int. J Heat Mass Transf 8, 419-426 (1965).
9. Finnicum, S. S. & Westwater, J. W. Dropwise vs filmwise condensation of steam on chromium. Int. J. Heat Mass Transf 32, 1541-1549 (1989).
10. Wilkins, D. G., Bromley, L. A. & Read, S. M. Dropwise and filmwise condensation of water vapor on gold. AIChE J. 19, 119-123 (1973).
11. Tanner, D. W., Pope, D., Potter, C. J. & West, D. Heat transfer in dropwise condensation part II surface chemistry. Int. J. Heat Mass Transf 8, (1965).
12. Huang, Z., Hwang, Y. & Radermacher, R. Review of nature-inspired heat exchanger technology. Int. J Refrig. 78, 1-17 (2017).
13. Jeevahan, J., Chandrasekaran, M., Britto Joseph, G., Durairaj, R. B. & Mageshwaran, G. Superhydrophobic surfaces: a review on fundamentals, applications, and challenges. J. Coatings Technol. Res. 15, 231-250 (2018).
14. Wong, T.-S. et al. Bioinspired self-reparing slippery surfaces with pressure-stable omniphobicity. Nature 477, 443-447 (2011).
15. Boreyko, J. B. & Chen, C. H. Self-propelled dropwise condensate on superhydrophobic surfaces. Phys. Rev. Lett. 103, 2-5 (2009).
16. Zhang, T. Y., Mou, L. W., Zhang, J. Y., Fan, L. W. & Li, J. Q. A visualized study of enhanced steam condensation heat transfer on a honeycomb-like microporous superhydrophobic surface in the presence of a non-condensable gas. Int. J. Heat Mass Transf 150, 119352 (2020).
17. Cheng, J., Vandadi, A. & Chen, C. L. Condensation heat transfer on two-Tier superhydrophobic surfaces. ASME Int. Mech. Eng. Congr. Expo. Proc. 7, 2649-2653 (2012).
18. Villegas, M., Zhang, Y., Abu Jarad, N., Soleymani, L. & Didar, T. F. Liquid-Infused Surfaces: A Review of Theory, Design, and Applications. ACS Nano 13, 8517-8536 (2019).
19. Rykaczewski, K. et al. Dropwise condensation of low surface tension fluids on omniphobic surfaces. Sci. Rep. 4, 1-9 (2014).
20. Seo, D., Shim, J., Lee, C. & Nam, Y. Brushed lubricant-impregnated surfaces (BLIS) for long-lasting high condensation heat transfer. Sci. Rep. 10, 1-13 (2020).
21. Stoddard, R., Nithyanandam, K. & Pitchumani, R. Steam Condensation Heat Transfer on Lubricant Infused Surfaces. iScience 24, 102336 (2021).
22. Preston, D. J., Song, Y., Lu, Z., Antao, D. S. & Wang, E. N. Design of Lubricant Infused Surfaces. ACS Appl. Mater. Interfaces 9, 42383-42392 (2017).
23. Anand, S., Paxson, A. T., Dhiman, R., Smith, J. D. & Varanasi, K. K. Enhanced condensation on lubricant-impregnated nanotextured surfaces. ACS Nano 6, 10122-10129 (2012).
24. Kong, T., Luo, G., Zhao, Y. & Liu, Z. Bioinspired Superwettability Micro/Nanoarchitectures: Fabrications and Applications. Adv. Funct. Mater. 29, 1-32 (2019).
25. Incropera, F., Dewitt, D., Bergman, T. & Lavine, A. Fundamentals of Heat and Mass Transfer. (John Wiley & Sons, 2007).
26. Guyer, J. P. An Introduction to condensers and auxillary equipment for steam power plants. 34 (2013).
27. Diez, J. A., Gratton, R., Thomas, L. P. & Marino, B. Laplace pressure driven drop spreading. Phys. Fluids 6, 24-33 (1994).
28. Nusselt, W. De oberflachenkondensation des waserdampfes. Z. VDI 541-546, 569-575 (1916).
29. Panuthara, J. P., Muttathara, J. P. M., Ramachandralal, R. M., Asirvatham, L. G. & Wongwises, S. Experimental investigation of condensation heat transfer on chlorotriethylsilane coated grooved vertical tube. Int. Commun. Heat Mass Transf 108, 104312 (2019).
30. Preston, D. J., Mafra, D. L., Miljkovic, N., Kong, J. & Wang, E. N. Scalable graphene coatings for enhanced condensation heat transfer. Nano Lett. 15, 2902-2909 (2015).
31. Haseli, Y., Dincer, I. & Naterer, G. F. Thermal effectiveness correlation for a shell and tube condenser with noncondensing gas. J. Thermophys. Heat Transf 22, 501-507 (2008).
32. Fakheri, A. Heat exchanger efficiency. J. Heat Transfer 129, 1268-1276 (2007).
33. Pattanayak, L., Padhi, B. N. & Kodamasingh, B. Thermal performance assessment of steam surface condenser. Case Stud. Therm. Eng. 14, 100484 (2019).
34. Figliola, R. S. & Beasley, D. E. Theory and design for mechanical measurements. Meas. Sci. Technol. 7, (1996).
35. Taylor, B. N. & Kuyatt, C. E. Guidelines for Evaluating and Expressing the Uncertainty of NIST Measurement Results. Technical Note 1297 (1994).

### Example 2: Analysis of Silica Fouling on Nonwetting Surfaces

Ground water sources used as coolant fluids in a variety of thermal systems such as heat exchangers and power plant condensers contain silica particles that accrete on heat transfer surfaces over time leading to reduction in thermal performance, a problem that is particularly exacerbated with temperature. Nonwetting superhydrophobic, solid-infused surfaces introduced herein demonstrate fouling mitigation, by virtue of their water repellency and reduced fouling of silica on the surfaces, especially under dynamic flow conditions and as a function of temperature. This example demonstrates a study of dynamic flow fouling of silica on nonwetting surfaces vis-à-vis conventional copper surface over a temperature range 20° C.-50° C. The mechanism of silica aggregate formation and its adherence to the different surfaces is elucidated by scanning electron microscope (SEM) imaging. Sigmoidal growth model is used to describe the time evolution of fouling thermal resistance and an Arrhenius model is presented for the temperature-dependent increase in the asymptotic fouling resistance on nonwetting and conventional surfaces alike. Lubricant-infused and solid-infused surfaces are shown to reduce fouling resistance by up to 25% and 13%, respectively, compared to conventional surface, whereas superhydrophobic surfaces lose their non-wettability under flow conditions, leading to an adverse increase in the fouling resistance by up to 13%. Considering the possible lubricant depletion in lubricant-infused surfaces over prolonged exposure to a flowing fluid, solid-infused surfaces present a robust alternative.

### Experimental Materials and Methods

### Materials

Plain (smooth) Copper tubes of inner diameter 7.9 mm and outer diameter 8.7 mm are purchased from McMaster-Carr (Elmhurst, Illinois, USA) along with several cleaning agents namely methanol, ethanol and acetone. Chemicals utilized for the fabrication of rough superhydrophobic surfaces namely, hydrochloric acid, n-hexadecyl mercaptan are purchased from Fisher Scientific (Hampton, New Hampshire, USA). For lubricant-infused surface, Krytox 104 oil and for solid-infused surface a two-part Gentoo polymer are obtained from Miller-Stephenson (Danbury, Connecticut, USA). A colloidal silica solution is purchased from Sigma-Aldrich (St. Louis, Missouri, USA).

### Surface Fabrication

Superhydrophobic surfaces were fabricated using the methods of chemical etching to generate roughness features inside a smooth copper tube followed by its functionalization. For etching, the samples were cleaned and covered on the outside and were immersed in a 1:1 by volume ratio of 12M hydrochloric acid and 3% hydrogen peroxide for 20 mins. The method of chemical etching, owing to the process of static immersion of samples in a solution bath, is scalable to different sample shapes and sizes. The cleaning procedure of all the samples was same where the samples were thoroughly washed with acetone. methanol and deionized (DI) water and air-dried before further procedure. Post etching, samples were washed thoroughly in DI water and dried at room temperature. Etched samples were then immersed in a bath of dilute solution of 0.02 mol·L⁻¹ Mercaptan in ethanol at 50° C. for one hour. At this stage the samples were washed in ethanol and allowed to dry at room temperature.

For the fabrication of Krytox 104 infused LIS, chemically etched superhydrophobic surfaces were placed tilted and Krytox oil was dripped uniformly on the top half of the sample from one end and compressed air was used to spread the oil within the tube. The same procedure was repeated from the other end until a uniform spreading of oil was achieved. After that, the oil was allowed settle down on the sample overnight before use.

For fabrication of SIS, the two parts of the Gentoo polymer solution were first mixed in a 1:1 ratio by weight and stirred for 120 minutes at room temperature. Next, the tube section was covered on the outer side and dipped into the Gentoo solution. Shortly after the dipping, the tube was rotated at around 1700 rpm for about 5 mins to uniformly spread the Gentoo solution within the surface and to avoid overfilling of the asperities. As a final step, the sample was cured at an elevated temperature of 90° C. for one hour. Note that Gentoo polymer was used here to introduce the novel class of surfaces, based on its hydrophobic nature, ease of fabrication, thermal robustness, and durability. The fabrication process, however, applies to other polymers as well.

### Experimental Setup and Procedures

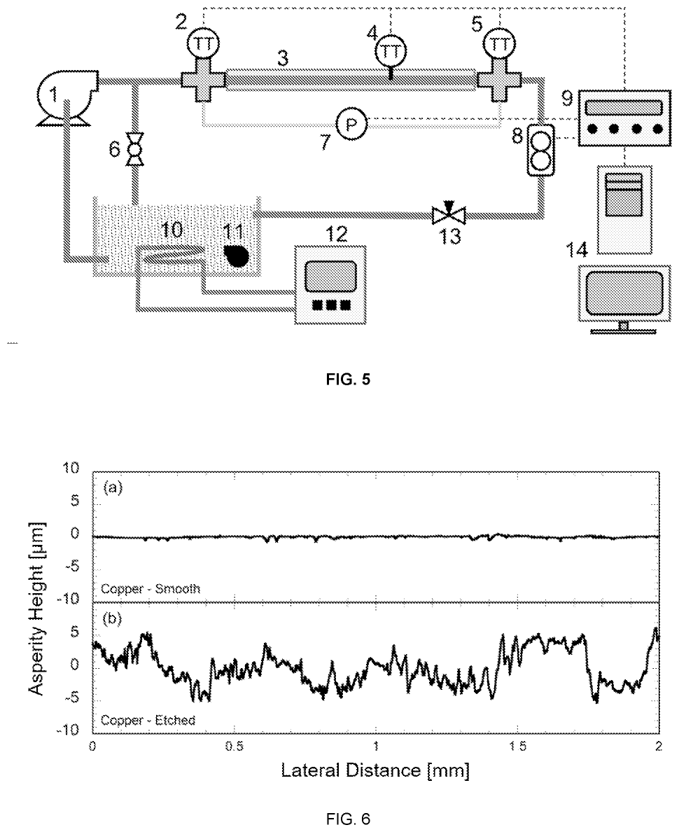

FIG. 5 shows a schematic of the experimental setup used to quantify the extent of heat transfer fouling on various surface. The setup includes a tank with an agitation pump and chiller loop (10, 11), a centrifugal pump (1), a test section bypass line controlled by a ball valve (6), and the test section line controlled by a needle valve (13). The test section was heated by a set of heater jackets (3) that cover the entire sample length of 20 cm. A total of three RTDs (2, 4, 5) with accuracy of ±0.05° C. are used for measuring test section inlet temperature (Tᵢ), outlet temperature (Tₒ), and outer wall temperature (T_{w}), along with a magnetic flowmeter (8) with accuracy of ±0.5% for measuring volumetric flowrate (V) through the test section. The data acquisition was done using National Instruments temperature (NI-9216) and multifunction (NI-9381) input modules (9) and LabView 2020 (14).

During each experimental run, the tank was first filled with 10 L of water and both the pumps were switched on with the bypass line valve full open. The needle valve was then adjusted to achieve a desired volumetric flow rate, \dot{V}, based on a target Reynolds number (Re) for the experiment and the chiller recirculatory was switched on. Using the chiller recirculator the desired tank temperature was achieved. Next, the heater jacket was activated and set to desired heat flux (˜3 kW/m²) while overall system operation was monitored for steady state. At this stage, the data acquisition was started and allowed to run for 15 minutes to obtain steady state value of V, Ti, To, and T_{w}. Next, the silica solution was added to the 10 L fluid tank to obtain an effective concentration of 1000 ppm. For the next several hours, the temperature and flow measurements are monitored. Once the outer surface temperature was observed to be saturated, the experiment was considered complete and the sample was removed and allowed to dry for 24 hours before SEM imaging.

### Data Reduction

The heat transfer rate from the heater jackets to silica fluid flow is expressed as:

$$\dot{q} = ρ \dot{V} {c}_{p} ( {T}_{o} - {T}_{i} ) \qquad ( 1 )$$

where ρ, \dot{V}, cₚ, Tᵢ, and Tₒ are the density, flow rate, specific heat capacity, inlet temperature and outlet temperature of the silica solution, respectively. From this, the total heat transfer thermal resistance can be obtained as:

$${R}_{T} = \frac{{A}_{s}}{\dot{q}} \cdot \frac{{T}_{o} - {T}_{i}}{ln ( \frac{{T}_{w} - {T}_{o}}{{T}_{w} - {T}_{i}} )} \qquad ( 2 )$$

where Aₛ is the outer surface area of the tube. As the silica aggregates deposit on the inside of the tube, the total thermal resistance gradually increases. From the total resistance, the initial unfouled resistance RT corresponding to the case of flow of water without the presence of silica for first 15 mins is subtracted to obtain the fouling resistance as:

$${R}_{f} = {R}_{T} - {R}_{T}^{0} \qquad ( 3 )$$

### Results and Discussion

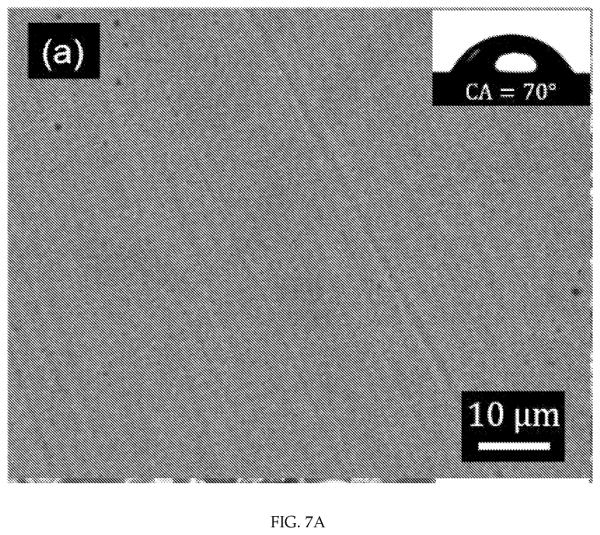

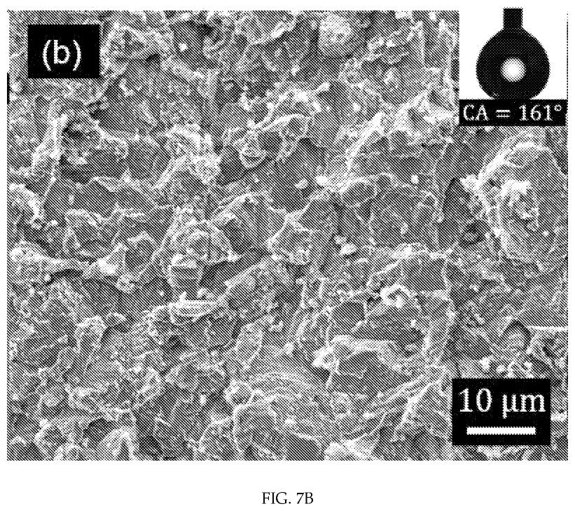

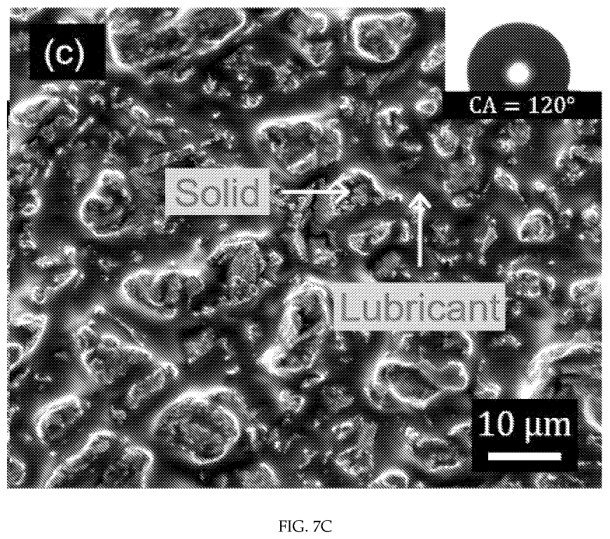

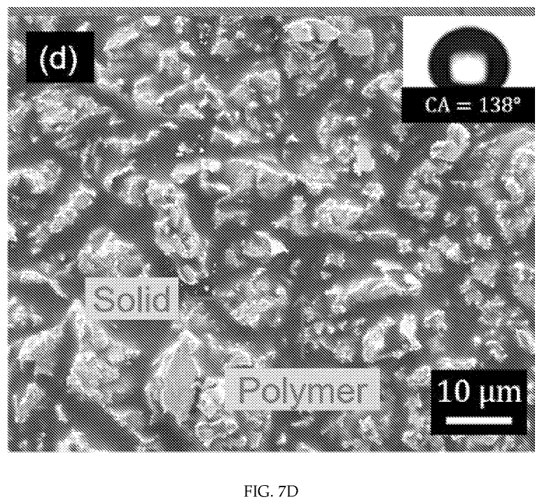

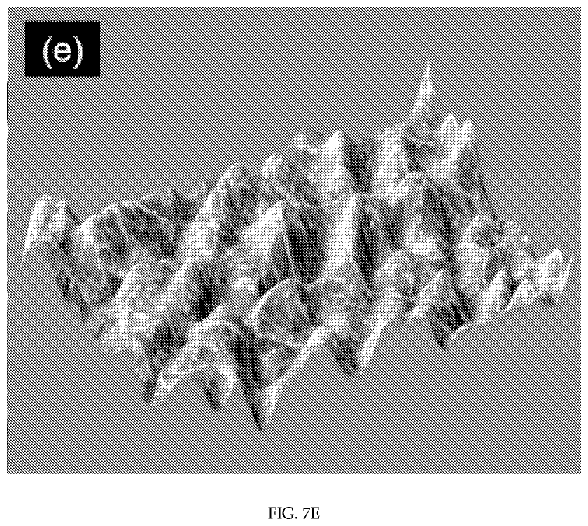

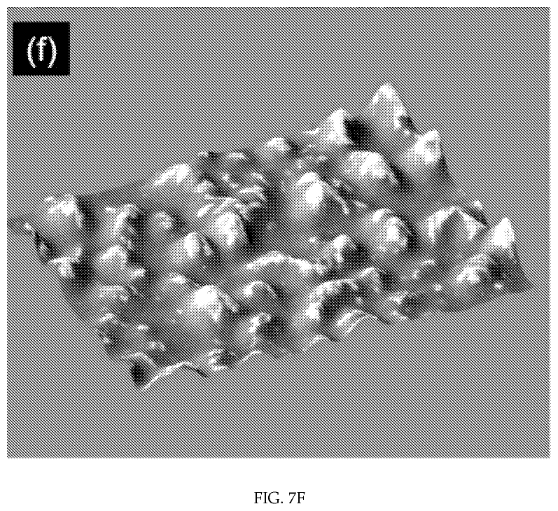

The process of chemical etching of smooth copper tubes results in the generation of roughness features. FIGS. 7A-7B show the profilometric scans of a smooth and rough copper tube surface. It is evident from FIG. 6A that smooth surface exhibits a more uniform profile with no discernible peaks and valleys, whereas FIG. 6B shows the existence of asperities at several length scales. The surface profile in FIG. 6B exhibits a maximum peak-to-valley height of ˜12 μm, an average roughness value of ˜6 μm and a root mean square (RMS) value of ˜7.3 μm. For a smooth surface profile (FIG. 6A), on the other hand, the maximum peak-to-valley height is measured to be ˜0.70 μm, the average roughness is ˜0.50 μm and the RMS value is ˜0.55 μm. In addition, the multiscale features on etched copper tubes are quantified in terms of their fractal dimension (D), determined from a Fast Fourier Transform (FFT) based power spectrum of the surface profile (REFS 15, 18, 30) shown in FIG. 6B, as D=1.70. In comparison, for a smooth surface, the homogenous profile results in fractal dimension values closer to 1, D≈1.05 (FIG. 6A). The information on the rough surface profiles, as presented in FIG. 6B for a sample rough copper tube, was used in determining the amount of lubricant and solid infusion for fabrication of just-filled LIS and SIS.

FIGS. 7A-7E show the scanning electron microscope (SEM) images of smooth, superhydrophobic, lubricant-infused and solid-infused copper surfaces to reveal their structural information. FIG. 7A shows that a smooth surface has no roughness features but a uniform appearance, also supported by the profilometric scan in FIG. 6A. On such a smooth copper surface, the contact angle of water drop is less than 90° (70° in FIG. 7A) categorizing it as a hydrophilic or wetting surface. On the other hand, all nonwetting surfaces-superhydrophobic, lubricant-infused and solid-infused surfaces-show apparent contact angle values greater than 90°, classifying them as hydrophobic surfaces. FIG. 7B (along with the profilometric scan in FIG. 6B) reveals the presence of asperities at multiple length scales on a superhydrophobic surface. Superhydrophobic surface (FIG. 7B), by virtue of trapped air in the valleys offers extreme repellency to the water with contact angle of 161°, well in the superhydrophobic range of contact angle ≳150°.

FIG. 7C shows a lubricant-infused surface where the valleys of roughness features are impregnated with Krytox 104, where the brighter islands distributed within the black background are the peaks of the asperities protruding out the infused lubricant, as marked. Owing to the slippery nature of the infused lubricant, LISs exhibit contact angle values in the range of 100-130°, as exemplified by the surface with a contact angle of 120° in FIG. 7C. FIG. 7D shows a solid-infused surface with cured Gentoo polymer (marked on the SEM) impregnated within the asperity valleys. Gentoo offers hydrophobic properties resulting in contact angle values in the range 110°-150° (138° in FIG. 7D). FIG. 7D shows brighter regions of peaks protruding out of the cured Gentoo that fill the valleys at roughly the same level of the peaks of the asperities. The infusion of Gentoo can be distinctly seen by comparing the three-dimensional isometric views of an etched rough surface in FIG. 7E with the Gentoo cured SIS in FIG. 7F. FIG. 7E shows the surface texture characterized by unfilled asperity valleys in an etched surface. The Gentoo polymer infused in the same surface shows the absence of deeper valleys indicating that the level of infused polymer is nearly at the same level as the top of the asperity elements.

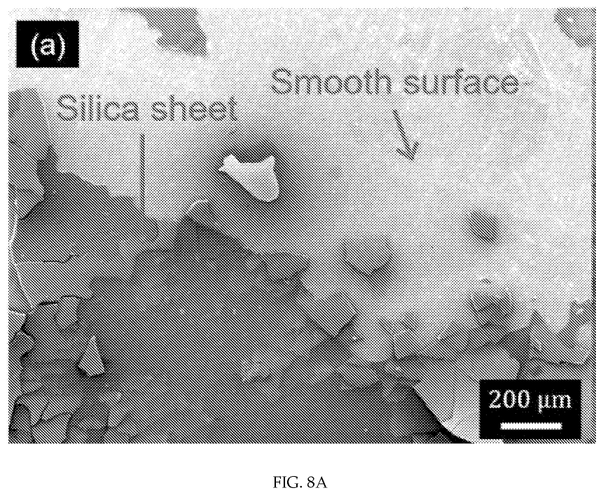

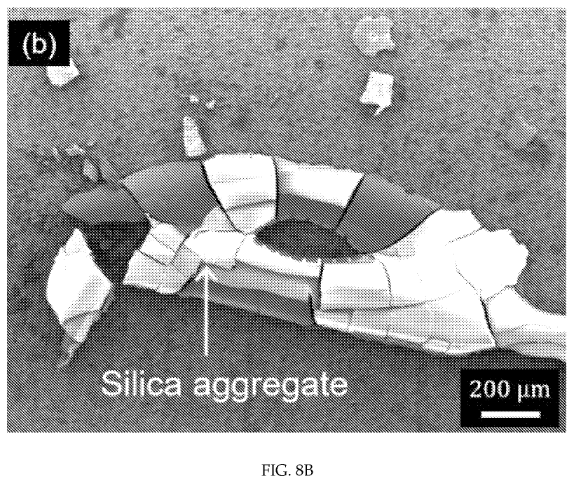

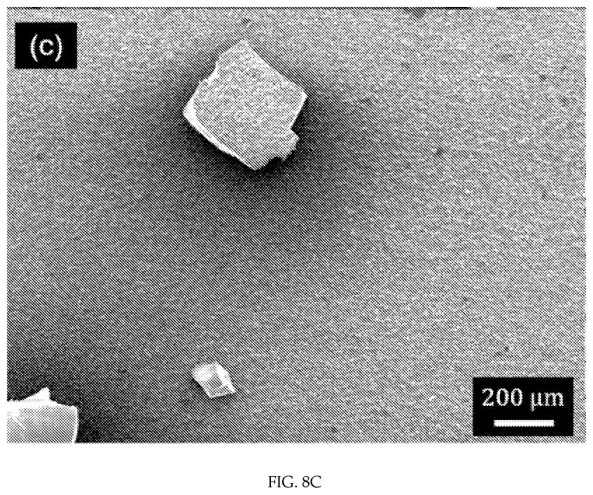

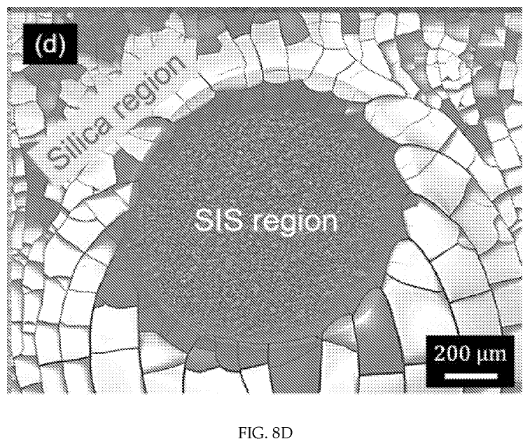

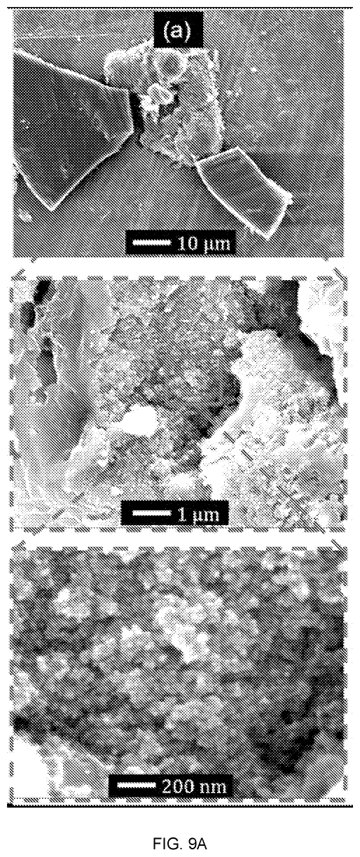

Fouling characteristics of aforementioned four types of surfaces on the inside of copper tubes were studied using a forced convection heat transfer setup, shown in FIG. 5, as per the experimental procedure described herein to quantify the extent of fouling in terms of a fouling thermal resistance. Following each experiment, the samples are allowed to dry, and sections of each sample are observed under an SEM. FIGS. 8A-8D show a set of SEM images of silica fouled tubes with smooth, superhydrophobic, lubricant-infused and solid-infused inner walls.

FIGS. 8A-8D collectively show that silica deposition on surfaces is in the form of aggregates formed from the agglomeration of dispersed silica particles. FIG. 8A exhibits that the silica aggregates have formed multiple layers of thin sheets covering the base smooth copper surface. Upon drying, the residual silica aggregates undergo crack formation as seen from FIG. 8A. FIG. 8B shows a region of silica-fouled superhydrophobic tube surface where a single larger aggregate of silica is seen. The central vacant part inside the aggregate as marked by red boundary is the region of residual dried droplet containing dispersed silica at the end of experimental run. The peripheral region undergoes solid aggregation of silica particles and undergoes crack formation upon drying. Similarly, FIG. 8C shows a sparse distributed deposition of silica aggregates on a Krytox 104-infused LIS surface. For the case of Gentoo-infused SIS tubes, a similar pattern of deposition as in smooth surfaces is seen from FIG. 8D. FIG. 8D reveals silica aggregates in the form of sheets in one region and a distinct region left out by the evaporated residual drops at the end of an experimental run, as identified approximately by the circular region at the center.

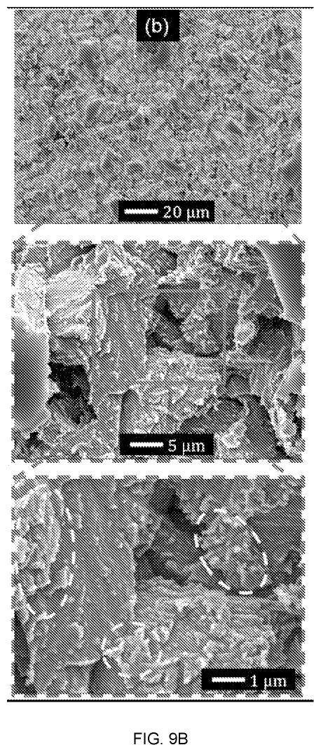

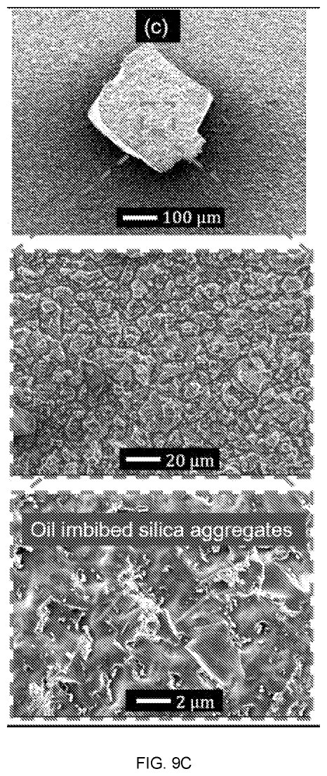

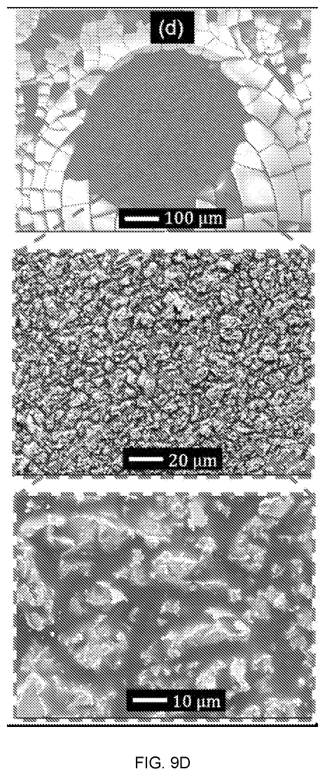

FIGS. 9A-9D show the interaction between the different surface types used in the present study and silica aggregates. FIG. 9A shows that for a smooth surface, a thin layer of silica aggregates stick to the surface and further growth of aggregates into larger bocks and sheets happens at random locations. From the zoomed-in images in the column of images under FIG. 9A, it is evident that the silica aggregates are porous in nature with the smallest aggregate size resolved in the SEM imaging being around 50 nm. Dispersed silica particles have an average diameter of around 25 nm resulting in a closed packing of aggregates that are easily adhered to heat transfer surfaces. The interaction of SHS with the silica aggregates is strikingly different compared to smooth surface. The presence of peaks and valleys of lengths scales on the order of micrometers on an SHS results in the deposition of silica aggregates deep within the valleys and its further growth on the surface. FIG. 9B shows a series of SEM images at increasing magnification that indicate the roots of larger silica aggregates are present either deep within the valleys or on the sides of the peaks, as identified by yellow regions in FIG. 9B, resulting in higher strength of the overall aggregate structures. This observation further suggests that the air cushion in an as-fabricated SHS that is the basis of the high Cassie state of nonwettability has been displaced by the flowing fluid, resulting a fully or partially Wenzel state of wettability.

LIS surfaces present an interesting interaction wherein the larger aggregates of silica imbibing the lubricant within their porous network. FIG. 9C shows that larger silica aggregates have compact packing of silica agglomerates with the presence of oil that is binding the aggregates together. The presence of lubricant oil is also evident from the absence of cracks in the dried silica aggregates as compared to the other surface types. For the case of silica fouling on SIS surfaces, the pattern of deposition is divided into two categories, first is the region of deposition where the silica aggregates are formed into sheets on the surface, and the second is the region where the residual drops are dried and vacant circular holes are formed on the aggregates. The zoomed-in images of the central hole under FIG. 9D show the bare SIS surface similar to FIG. 7D, with no residue of silica aggregates.

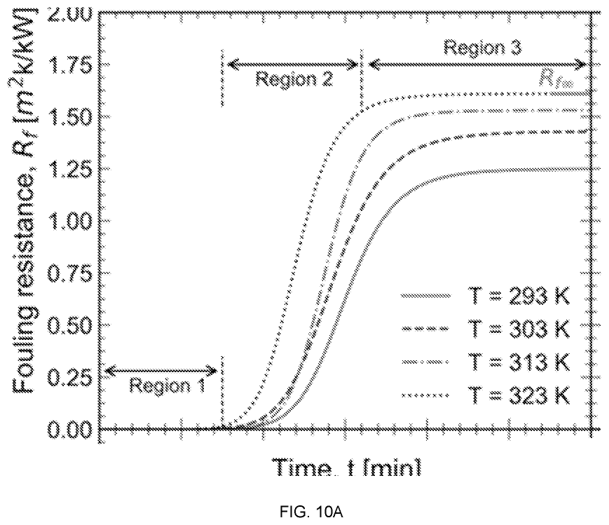

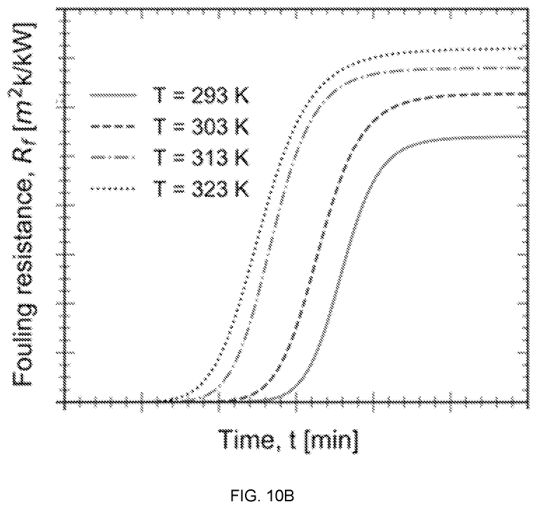

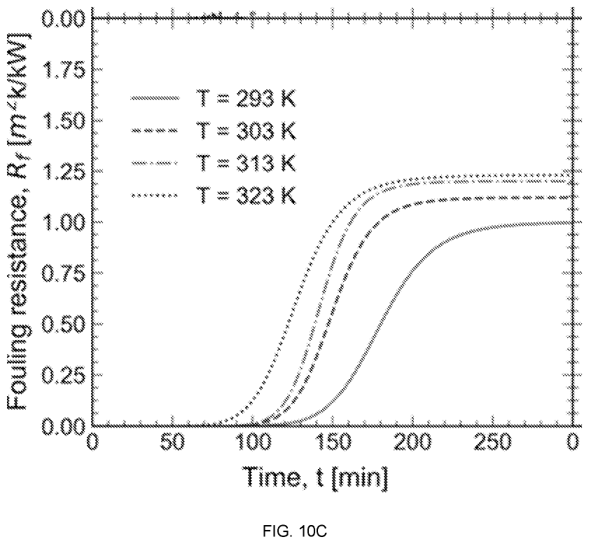

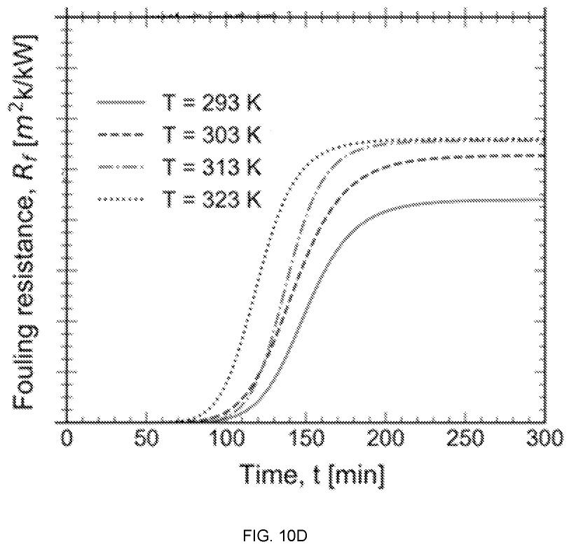

Building on the qualitative information on the interaction of surface structure type and silica aggregates presented so far, FIGS. 10A-10B quantify the extent of fouling of silica onto the different heat transfer surfaces in terms of the variation of fouling resistance with time. FIGS. 10A-10B show that for all four surface types and for all average inlet temperature values of foulant flow, the fouling resistance first remains zero (Region 1) and then gradually increases with time (Region 2) followed by its asymptotic convergence to the asymptotic fouling resistance, R_{f∞} (Region 3). The three regions are illustrated in FIG. 10A, but apply to all the surfaces. At t=0 the induction of foulant in the flowing fluid does not result in its deposition onto heat transfer surface at the very beginning. With increasing time, the dispersed silica particles form deposits at several nucleation sites on the surface. At this stage, the force of adhesion by the surface attracts more foulant deposition and with its subsequent growth and spread on the heat transfer surface. During this period the fouling resistance increases with time. As the foulant deposits grow in size, the shear caused by the flowing fluid results in gradual removal of the deposited foulant. During this period the growth rate of thermal fouling resistance decreases. The competing effects of surface adhesion and shear by the flowing fluid results in an asymptotic fouling thermal resistance, as indicated in FIG. 10A.

The nature of fouling resistance variation with respect to time, seen in FIGS. 10A-10B, can be modeled by a sigmoidal growth curve expressed mathematically as:

$${R}_{f} ( t ) = {R}_{f ∞} ( 1 - \frac{1}{1 + {( t / {t}_{0} )}^{k}} ) \qquad ( 4 )$$

where R_{f∞} is the asymptotic fouling resistance, t₀ is the time instance of change of curvature of R_{f} vs t and k is a constant that relates to the rate of increase of fouling resistance at t=t₀. FIGS. 10A-10B show that for all four surface types, at any given time instant, a higher fluid flow temperature results in a higher fouling resistance. Increase in fouling resistance at any given time is attributed to two reasons: first, increase in fluid flow temperature increases the surface temperature thereby decreasing the surface tension of water, resulting in easy spreading and higher adhesion of foulant fluid on heat transfer surface. Over the range of temperature studied 20° C. to 50° C., the interfacial water-air tension decreases from 72 mN/m to 67 mN/m (Ref 31). In addition, at higher temperatures the kinetics of aggregation of silica particles significantly increases (Ref 32) leading to the early deposition of larger aggregates and a greater rate of deposition, leading to higher fouling thermal resistance.

FIGS. 11A-11B present the variation of asymptotic fouling resistance, R_{f∞}, with flow inlet temperature, T. It is evident from FIG. 11A that for all temperature values considered in the study, the asymptotic fouling resistance increases with temperature, by about 33% for SHS and about 23%, 27% and 29% for the LIS, SIS and smooth surface, respectively. SHS consistently shows higher asymptotic thermal resistance followed by smooth surface, then Gentoo infused SIS surface and the least asymptotic thermal resistance is shown by Krytox 104 infused LIS. The higher asymptotic fouling resistance for SHS compared to smooth surfaces is attributed to the possible transition of flow from Cassie to Wenzel state. In the Wenzel state the foulant fluid flow penetrates the valleys of the rough asperities, resulting higher exposed area and exposure to more surface nucleation sites. Furthermore, the growth of silica aggregates within the valleys of SHS leads to the higher adhesion of deposit layers on to the SHS heat transfer surface.

In LIS, the presence of lubricant lowers the nucleation areas on the surface and further, since the flowing liquid glides easily on the surface, the interaction between the fluid and the surface is reduced, as seen from the least values of R_{f∞} in FIG. 11A. The case of Gentoo infused SIS is unique, where the presence of cured polymer within the valleys of a rough surface results in an effective area for the deposition of foulant similar to that of a smooth surface. On the other hand, the hydrophobic nature of Gentoo reduces the interaction with the external fluid flow, leading to lower asymptotic fouling resistance compared to smooth surface. However, since the effective area for nucleation is greater for SIS than LIS, R_{f∞} for SIS is greater than that for LIS, as seen from FIG. 11A. Overall, LIS and SIS show about 25% and 13% reduction in the asymptotic fouling resistance, respectively, compared to smooth surface, whereas SHS has a 13% increase in the asymptotic fouling resistance with respect to a smooth surface, over the entire range of temperature studied.

In order to establish a functional dependence of asymptotic fouling resistance with temperature, an Arrhenius relationship is used owing to the similarity of fouling kinetics to chemical reaction rates. The mathematical expression for the Arrhenius relationship is given as:

$${R}_{f ∞} = {R}_{f ∞}^{*} {e}^{- \frac{{T}^{*}}{T}} \qquad ( 5 )$$

where the pre-exponential factor R*_{f∞} is the saturated asymptotic fouling resistance as, theoretically, the temperature, T, approaches infinity. As T→∞, the asymptotic fouling resistance theoretically saturates as the effects of increasing temperatures on the formation of larger aggregates and increasing adhesion of flowing fluid to the surface diminishes. The exponential factor T* determines an activation temperature value where the saturating asymptotic fouling resistance starts to build.

In the present study, the values of constants R*_{f∞} and T* for the four different types of surfaces were determined through a least-squares regression fit through the measured data of R_{f∞} with absolute temperature (in Kelvin). FIG. 11B presents the measured R_{f∞} with the inverse of the absolute temperature on a semi-log plot, such the Arrhenius equation is a linear variation on this plot with a negative slope whose magnitude equates to R*_{f∞}, and the intercept of the line on the ordinate is ln T*. FIG. 11B shows that the data points all lie closely along such straight lines, which confirms the Arrhenius nature of the temperature dependence of the asymptotic fouling resistance for all the four surfaces. The dashed lines in the plot denote the least-squares linear regression fits, from which the derived values of R*_{f∞} and T* are summarized in Table 1. It is evident from the values of R*_{f∞} in Table 1, that LIS has the least saturation fouling resistance that is about one-half of the saturation resistance for a smooth surface and SIS presents about 23% lower saturation resistance compared to the smooth surface. In comparison, SHS has a 58% higher saturation fouling resistance relative to the smooth surface.

TABLE 1
Constants in Arrhenius relationship (eq. 5) for various surface types

| Surface type | R_{f∞}* | T* [K] |
|---|---|---|
| Smooth | 18.7 | 787 |
| SHS | 29.5 | 897 |
| LIS | 9.6 | 658 |
| SIS | 14.5 | 743 |

Solid-infused nonwetting surfaces were introduced for the first time in this article and their performance was assessed by considering silica fouling mitigation. The potential uses of the surfaces are many including boiling heat transfer enhancement, promoting dropwise condensation, corrosion mitigation, among others, which will be considered in future studies. The present study considered chemical etching as a common facile texturing method for comparison of SHS, LIS and SIS. The effects of other surface texturing methods (such as electrodeposition) to produce different asperity structures may be considered in a future study. Similarly, the role of different infusion materials for LIS (for example, Krytox 101-105, silicone oils, etc.) and SIS (e.g. Sylgard), and a possible composite infusion of oils and polymers may also be pursued, building on the approach and results presented in this article. Durability of nonwetting surfaces is an important consideration, which is explored in separate studies (Refs 12, 33), that the reader is referred to.

### CONCLUSIONS

In the present example, systematic experiments are presented to elucidate the fouling kinetics of silica on smooth, superhydrophobic, lubricant-infused and solid-infused copper tube surfaces. Silica adhesion characteristics on the various surface types is demonstrated with scanning electron microscopic imaging. The extent of fouling is quantified in terms of a fouling thermal resistance and the following salient points were elucidated:

SHS show consistently higher fouling by about 13% compared to smooth surface, owing to the Cassie to Wenzel transition that causes the silica dispersed fluid flow to penetrate and grow silica aggregates within the asperity valleys of SHS.

Krytox 104 infused LIS exhibits the least fouling, about 25% lower than a smooth surface, owing to the presence of slippery infusion liquid within the valleys that offers reduced interaction between the surface and the fluid flow.

Gentoo cured SIS demonstrated an appreciable fouling reduction of 13% compared to smooth surface, but higher fouling than LIS.

Studies at the higher temperatures showed that the fouling increases with temperature for all surfaces, that can be described well using Arrhenius kinetics. Again, LIS and SIS demonstrated a lower increase of 23% and 27% in the asymptotic fouling resistance with temperature, compared to 29% for a smooth surface and a 33% increase for SHS.

Overall, LIS presents a viable option for heat transfer surfaces to mitigate fouling by silica. However, considering the possible depletion of the beneficial lubricant in LIS over prolonged exposure to a flowing fluid, SIS presents a robust alternative.

### REFERENCES FOR EXAMPLE 2

[1] E. Nebot, J. F. Casanueva, T. Casanueva and D. Sales, Model for Fouling Deposition on Power Plant Steam Condensers Cooled with Seawater: Effect of Water Velocity and Tube Material. Int. J. Heat Mass Transf. (2007), 50 (17-18), 3351-3358. doi:10.1016/j.ijheatmasstransfer.2007.01.022.
[2] X. Zhao and D. C. Xiao, A Critical Review of Basic Crystallography to Salt Crystallization Fouling in Heat Exchangers. Heat Transfer Engineering 34.8-9 (2013): 719-732. doi:10.1080/1457632.2012.739482
[3] J. W. Suitor, W. J. Marner and R. B. Ritter, The History and Status of Research in Fouling of Heat Exchangers in Cooling Water Service. The Canadian Journal of Chemical Engineering 55.4 (1977): 374-380. doi:10.1002/cjce.5450550402
[4] H. Müller-Steinhagen, Heat transfer fouling: 50 Years After the Kern and Seaton Model. Heat Transfer Engineering 32.1 (2011): 1-13. doi:10.1080/01457632.2010.505127
[5] K. D. Demadis, Combating Heat Exchanger Fouling and Corrosion Phenomena in Process Waters. Compact Heat Exchangers and Enhancement Technology for the Process Industries, 483-490 (2003).
[6] D. B. van den Heuvel, E. Gunnlaugsson and L. G. Benning, Surface roughness affects early stages of silica scale formation more strongly than chemical and structural properties of the substrate. Geothermics, 87 (2020), 101835. doi.org/10.1016/j.geothermics.2020.101835
[7] S. H. Chan, H. Rau, C. DeBellis and K. F. Neusen, Silica fouling of heat transfer equipment-Experiments and model, (1988). doi.org/10.1115/1.3250583
[8] 1. Gunnarsson and S. Arnorsson, Impact of silica scaling on the efficiency of heat extraction from high-temperature geothermal fluids. Geothermics, 34(3) (2005), 320-329, doi.org/10.1016/j.geothermics.2005.02.002
[9] C. Ning, L. Mingyan and Z. Weidong, Fouling and corrosion properties of SiO2 coatings on copper in geothermal water. Industrial & engineering chemistry research, 51(17) (2012), 6001-6017. doi.org/10.1021/ie202091b
[10] P. J. R. Schreier and P. J. Fryer, Heat exchanger fouling: a model study of the scaleup of laboratory data. Chemical engineering science, 50(8) (1995), 1311-1321. doi.org/10.1016/0009-2509(95)98843-4
[11] R. Jain and R. Pitchumani, Facile Fabrication of Durable Copper-Based Superhydrophobic Surfaces via Electrodeposition. Langmuir, 34(10) (2017), 3159-3169. doi.org/10.1021/acs.langmuir.7b02227
[12] R. Stoddard, K. Nithyanandam and R. Pitchumani, Fabrication and Durability Characterization of Superhydrophobic and Lubricant-Infused Surfaces. Journal of Colloid and Interface Science, 608, (2022), 662-672. doi.org/10.1016/j.jcis.2021.09.099
[13] S. Hatte and R. Pitchumani, Analytical Model for Drag Reduction on Liquid-infused Structured Non-wetting Surfaces. Soft Matter 17(5) (2021): 1388-1403. doi:10.1039/D0SM01272F
[14] Y. Tuo, H. Zhang, W. Rong, S. Jiang, W. Chen and X. Liu, Drag Reduction of Anisotropic Superhydrophobic Surfaces Prepared by Laser Etching, (2019). doi:10.1021/acs.langmuir.9b01040.
[15] S. Hatte and R. Pitchumani, Fractal Model for Drag Reduction on Multiscale Nonwetting Rough Surfaces. Langmuir 36, no. 47 (2020): 14386-14402. doi: 10.1021/acs.langmuir.0c02790.
[16] K. Kant and R. Pitchumani, Laminar Drag Reduction in Microchannels with Liquid infused Textured Surfaces. Chemical Engineering Science 230 (2021): 116196. doi:10.1016/j.ces.2020.116196
[17] S. Hatte and R. Pitchumani, Analysis of Laminar Convective Heat Transfer Over Structured Non-Wetting Surfaces, Int. J. Heat Mass Transf. 167 (2021) 120810. doi:10.1016/j.ijheatmasstransfer.2020.120810.
[18] S. Hatte and R. Pitchumani, Analysis of Convection Heat Transfer on Multiscale Rough Superhydrophobic and Liquid Infused Surfaces. Chemical Engineering Journal 424 (2021): 130256. doi:10.1016/j.cej.2021.130256
[19] R. Stoddard, K. Nithyanandam and R. Pitchumani, Steam Condensation Heat Transfer on Lubricant-infused Surfaces, IScience. 24 (2021) 102336. doi:10.1016/j.isci.2021.102336.
[20] S. M. A. Mousavi and R. Pitchumani, Bioinspired Nonwetting Surfaces for Corrosion Inhibition Over a Range of Temperature and Corrosivity. Journal of Colloid and Interface Science, 607, (2022), 323-333. doi:10.1016/j.jcis.2021.08.064
[21] S. M. A. Mousavi and R. Pitchumani, A Study of Corrosion on Electrodeposited Superhydrophobic Copper Surfaces. Corrosion Science, 186, (2021) 109420. doi:10.1016/j.corsci.2021.109420
[22] P. Zhang, L. Lin, D. Zang, X. Guo and M Liu, Designing Bioinspired Anti-Biofouling Surfaces based on a Superwettability Strategy. Small, 13(4) (2017) 1503334. doi:10.1002/smll.201503334
[23] M. Ferrari, and A. Benedetti, Superhydrophobic Surfaces for Applications in Seawater. Advances in colloid and interface science, 222 (2015) 291-304. doi:10.1016/j.cis.2015.01.005
[24] J. Genzer, and K. Efimenko, Recent Developments in Superhydrophobic Surfaces and Their Relevance to Marine Fouling: a Review. Biofouling, 22 (5) (2006) 339-360. doi:10.1080/08927010600980223
[25] S. B. Subramanyam, G. Azimi and K. K. Varanasi, Designing Lubricant-Impregnated Textured Surfaces to Resist Scale Formation. Advanced Materials Interfaces, 1 (2) (2014) 1300068. doi:10.1002/admi.201300068
[26] W. Jiang, J. He, F. Xiao, S. Yuan, H. Lu and B. Liang, Preparation and Antiscaling Application of Superhydrophobic Anodized CuO Nanowire Surfaces. Industrial & Engineering Chemistry Research, 54(27) (2015) 6874-6883. doi:10.1021/acs.iecr.5b00444
[27] M. F. B. Sousa, G. F. Barbosa, F. Signorelli and C. A. Bertran, Anti-scaling Properties of a SLIPS Material Prepared by Silicon Oil Infusion in Porous Polyaniline Obtained by Electropolymerization. Surface and Coatings Technology, 325 (2017) 58-64. doi:10.1016/j.surfcoat.2017.06.038
[28] S. Hatte and R. Pitchumani, Generalized Analysis of Dynamic Flow Fouling on Heat Transfer Surfaces. International Journal of Heat and Mass Transfer, (2022) 122573. doi:10.1016/j.ijheatmasstransfer.2022.122573.
[29] R. Pitchumani and R. Stoddard, Solid Infused Surfaces for High Efficiency Condensation, Provisional U.S. Patent 63/185,973.
[30] R. Jain and R. Pitchumani, Fractal Model for Wettability of Rough Surfaces. Langmuir, 33(28), (2017), 7181-7190. doi:10.1021/acs.langmuir.7b01524
[31] Engineering ToolBox, (2004). Surface Tension of Water in contact with Air.
[32] M. Tourbin and C. Frances, Monitoring of the Aggregation Process of Dense Colloidal Silica Suspensions in a Stirred Tank by Acoustic Spectroscopy. Powder technology, 190(1-2) (2009), 25-30. doi:10.1016/j.powtec.2008.04.067
[33] S. M. A. Mousavi and R. Pitchumani, A Comparative Study of Mechanical and Chemical Durability of Non-wetting Superhydrophobic and Lubricant-Infused Surfaces. Colloids and Surfaces A: Physicochemical and Engineering Aspects, 643, (2022) 128711. doi:10.1016/j.colsurfa.2022.128711.

### Example 3. Nonwetting Solid-Infused Surfaces for Superior Fouling Mitigation

This example presents a systematic study of the fouling mitigation performance of SIS in comparison to state-of-the-art lubricant-infused surface (LIS) and conventional smooth surface. Copper tubes with SIS, LIS or smooth inner walls are fabricated and subjected to accelerated calcium sulfate fouling in a flow fouling experimental setup. Fouling on the various surface types is quantified in terms of asymptotic fouling resistance, and the fundamental morphological differences in the interactions of the foulant and the various surface types are analyzed. Based on a systematic sweep of the parameter combinations using design of experiments and Taguchi analysis, an analytical dependence of asymptotic fouling resistance on the governing parameters namely, Reynolds number, foulant concentration and temperature is derived. The analytical model is shown to predict the asymptotic fouling resistance to within 20% accuracy with a 95% confidence. In addition, the effects of shear durability on the fouling mitigation performance of LIS vis-à-vis SIS are studied. It is shown that the nonwetting SIS offers a robust option for superior fouling mitigation over LIS in the long run.

### Experimental Materials and Methods

### Materials

Copper tubes of inner diameter 7.9 mm and wall thickness 0.8 mm are purchased from McMaster-Carr (Elmhurst, Illinois, USA) along with chemicals used for the sample cleaning purposes namely, methanol, ethanol and acetone of purest form. Chemicals utilized for the fabrication of rough surfaces namely, hydrochloric acid, n-hexadecyl mercaptan were purchased from Fisher Scientific (Hampton, New Hampshire, USA), along with the chemical required to produce calcium sulfate in lab namely, calcium nitrate tetrahydrate and sodium sulfate. For lubricant infused surface, Krytox 104 oil was purchased from Miller-Stephenson (Danbury, Connecticut, USA). For the fabrication of solid-infused surfaces, a two-part Gentoo polymer was purchased from Thor Spill Products (USA).

### Fabrication

Three different surface types namely solid-infused, lubricant-infused and smooth surfaces were prepared for the study. The preparation of a smooth copper tube consisted of cleaning by rinsing in acetone, methanol and deionized water, in the order, followed by drying in a laminar flow hood at room temperature for one hour. Smooth copper tubes thus prepared were used in SIS and LIS fabrication as well as in baseline fouling experiments.

Fabrication of solid-infused surface started with chemical etching of the inside of a smooth copper tube to generate roughness features on the inner surface. Cleaned and dried smooth copper tube (as per the procedure above) was masked on the outside using a painter's tape and then immersed in a chemical bath of 1:1 solution of 12M hydrochloric acid and 3% hydrogen peroxide for 20 minutes at room temperature. Following the etching process, the sample was removed from the chemical bath and rinsed with deionized (DI) water and ethanol vigorously to remove residual copper removed during etching process and dried at room temperature in a laminar flow hood. At this stage, the rough copper tube was ready for the infusion of Gentoo polymer. The two-part Gentoo solution was first created by mixing part A and part B in 1:1 ratio by weight using magnetic stirrer for about 1 hour. Next, the Gentoo solution was dripped on the inside of the chemically etched rough copper tube using a micro-pipette and spread evenly using compressed air. Following this, the Gentoo infused sample was vertically placed inside an oven and cured at 90° C. for one hour. After that, the sample was allowed to cool down at room temperature to produce a copper tube with a solid-infused inner surface. Copper tubes with SIS on the inside were then ready for characterization and fouling experiments.

Fabrication of lubricant infused surface started with the fabrication of chemically etched rough inner surface of the copper tube as the first step. Following that, the rough copper tube was masked on the outer side and the inner surface was functionalized in a chemical bath of 0.02 mol L⁻¹ solution of n-hexadecyl mercaptan in ethanol at 60° C. for one hour. Upon functionalization, the sample was removed and rinsed with ethanol and allowed to dry at room temperature in a laminar hood. At this stage, the inside of the tube was superhydrophobic. The dried superhydrophobic copper tube inner surface was then infused with Krytox 104 oil by dripping it inside the tube and using compressed air to spread it evenly. Following that, the lubricant-infused tube was placed vertically for about 12 hours to get rid of excess lubricant to obtain just-filled asperity structures. Tubes with lubricant-infused inner surfaces fabricated using this procedure were ready for surface characterization and fouling experiments.

### Surface Characterization

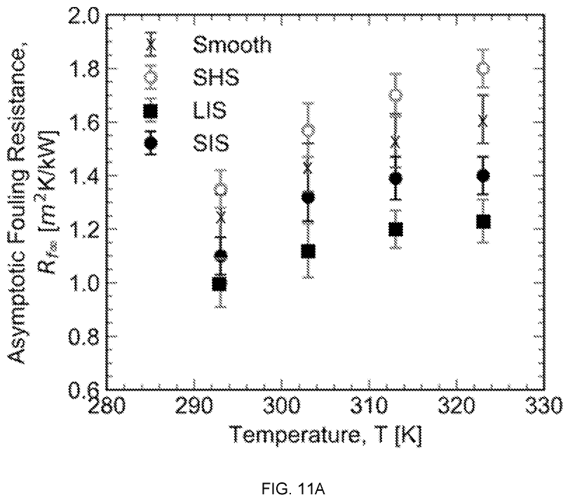

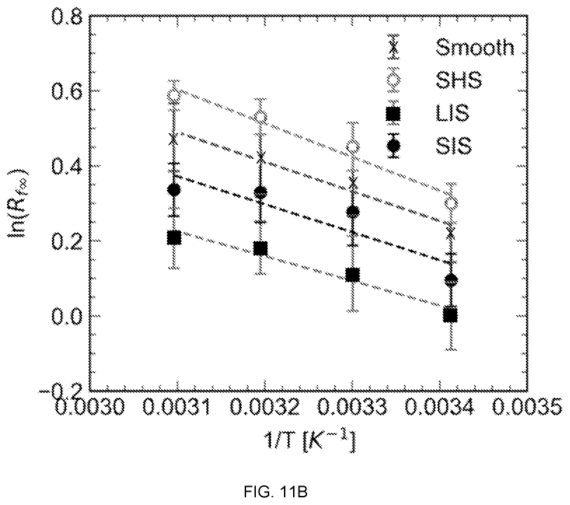

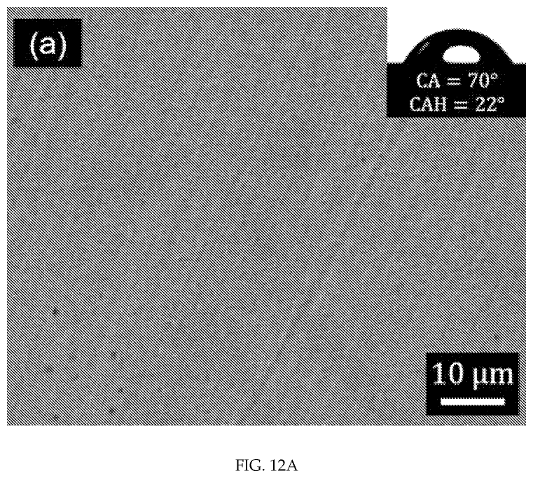

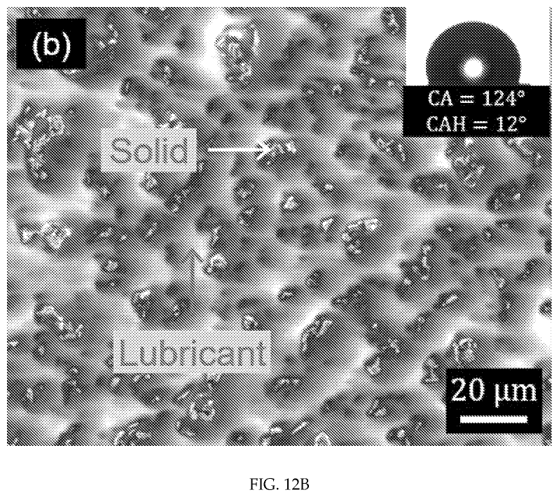

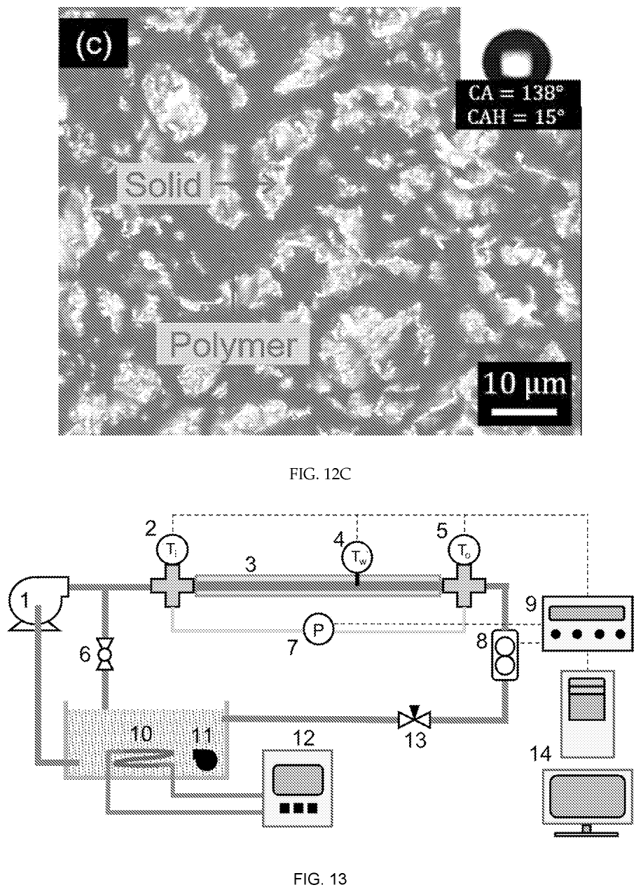

FIGS. 12A-12C show the scanning electron microscope (SEM) images of smooth, lubricant-infused and solid-infused inside surfaces of copper tubes used in the fouling experiments. Smooth surface, by virtue of absence of any roughness features and inherent hydrophilic nature of the copper material shows a low water contact angle value of 70° and relatively high contact angle hysteresis of 22°. Lubricant-infused surfaces on the other hand have roughness features of several length scales and lubricant-infused within the interstitial region as evident from FIG. 12B, where the darker grey region is infused Krytox 104 and the brighter grey islands are the asperities slightly protruding out of the sea of lubricant. The slippery nature of the infused lubricant renders the surface hydrophobic with contact angle of 124° and a relatively low contact angle hysteresis value of 12°. A solid-infused surface with cured Gentoo polymer in the interstitial space of the roughness features looks similar to a LIS as per SEM image shown in FIG. 12C. The solid polymer infusion in the asperity valleys leads to a larger contact angle of 138° and a slightly larger contact angle hysteresis value of 15°, than LIS.

### Experimental Setup and Data Reduction

The experimental setup and methodology followed that reported in our previous work [Ref. 32], which is reviewed here for completeness. FIG. 13 shows a schematic of the experimental setup used to quantify heat transfer fouling characteristics of various surfaces. The primary mechanical components of the system included a tank with an agitation pump and chiller loop (10, 11), a centrifugal pump (1) to circulate the scaling solution, a test section bypass line controlled by a ball valve (6), and the test section line controlled by a needle valve (13). The test section was heated by a heater jacket (3) comprised of three, flexible, alternating current (AC) polyimide heaters connected to a variable, AC transformer. Instrumentation of the apparatus consisted of three Class A resistance temperature detectors (RTDs—2, 4, 5) with accuracy of ±0.05° C. for measuring test section inlet temperature (Tᵢ), outlet temperature (Tₒ), and exterior wall temperature (T_{w}), as well as a magnetic flowmeter (8) with accuracy of ±0.5% for measuring volumetric flowrate (\dot{V}) through the test section. All gauge measurements were acquired and displayed using National Instruments temperature (NI-9216) and multifunction (NI-9381) input modules (9) and LabView 2020 (14).

The setup was used to conduct accelerated fouling studies by using a high concentration of the foulant compared to what would be found in practice, so as to comparatively study the growth and characteristics of fouling on the various surfaces in a short period of time. For each accelerated fouling experimental run, the tank was filled with 20 L water and was run through the test section for about 15 minutes at the desired Reynolds number and at the desired foulant inlet temperature by adjusting the chiller recirculator temperature. Next, the heat jackets were switched on and steady state conditions were achieved for fluid flow and inlet outlet temperatures. After 15-20 mins of observing the steady state measurement for flow of water through test section, specific amounts of calcium nitrate and sodium sulfate were added in the 20 L water tank to generate a desired concentration of calcium sulfate, as per the following balanced chemical equation:

$${Ca ( {NO}_{3} )}_{2} \cdot 4 {H}_{2} O + {Na}_{2} {SO}_{4} \to {CaSO}_{4} \cdot 2 {H}_{2} O + 2 {NaNO}_{3} + 2 {H}_{2} O \qquad ( 1 )$$

At this stage, the inlet, outlet and wall temperatures along with flow rate measurements were started to be recorded. The experiment was considered complete when T_{w} showed no increase over a 30-minute period. After the fouling experiment, the tube test section was removed from the apparatus and allowed to dry for 24 hours before preparing for SEM imaging.

Data reduction to obtain the fouling resistance was based on the following calculations. For the flow of foulant solution inside the tubes, the heat transfer rate from the heater jackets to the flowing fluid was obtained as:

$$\dot{q} = ρ \dot{V} {c}_{p} ( {T}_{o} - {T}_{i} ) \qquad ( 2 )$$

where ρ, \dot{V}, cₚ, Tᵢ, and Tₒ are the density, flow rate, specific heat capacity, inlet temperature and outlet temperature of the foulant solution, respectively. Using the heat transfer rate, the total thermal resistance can be expressed as:

$${R}_{T} = \frac{{A}_{s}}{\dot{q}} \cdot \frac{{T}_{o} - {T}_{i}}{ln ( \frac{{T}_{w} - {T}_{o}}{{T}_{w} - {T}_{i}} )} \qquad ( 3 )$$

where T_{w} is the wall temperature and Aₛ is the outer surface area of the tube. Next, to measure the effect of fouling on the heat transfer resistance, the initial unfouled resistance R_{T}⁰ corresponding to the case of flow of water without the presence of any fouling agent is subtracted from the total thermal resistance to obtain:

$${R}_{f} = {R}_{T} - {R}_{T}^{0} \qquad ( 4 )$$

In the present example, three different parameters governing the fouling phenomenon are identified as: Reynolds number, dimensionless foulant concentration and foulant inlet temperature. The non-dimensional foulant concentration was obtained as the ratio of the actual concentration (c) to the solubility of calcium sulfate in water, s=2.6×10⁻³ g/ml. Experiments were conducted for three levels of Reynolds number, Re=1000, 2000, and 3000, three levels of foulant concentration ratio, c/s=2.0, 2.5, and 3.0, and four levels of temperature, T=293, 303, 313 and 323 K. The parametric combinations studied, and the results are described in the next section.

### Results and Discussion

### Morphological Characterization

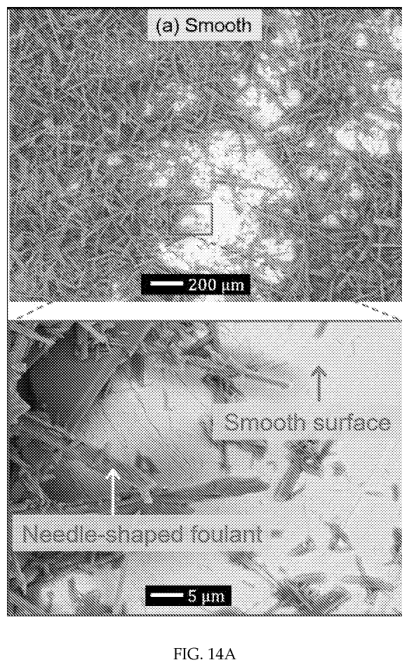

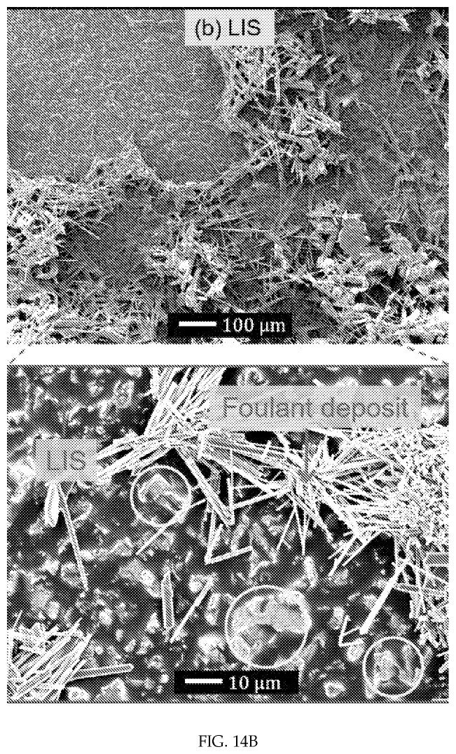

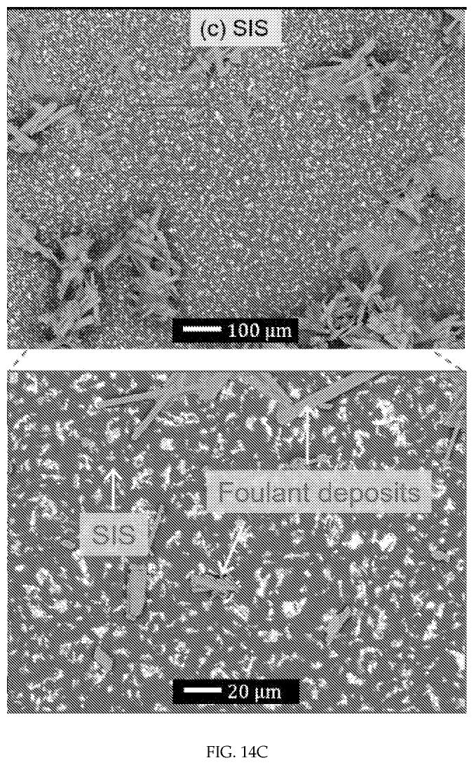

FIGS. 14A-14C show the SEM images of calcium sulfate fouled smooth, lubricant-infused, and solid-infused surfaces at various magnifications to elucidate the differences in the foulant-surface interaction at micrometer length scales. FIGS. 14A-14C shows that across all surface types, calcium sulfate deposits in the form of a complex structure of smaller needles that come together to form a dense mesh like structure. Such needle-shaped features are the fundamental calcium sulfate deposits irrespective of operating conditions and surface type. FIG. 14A shows that for a smooth surface, the homogeneity of surface results in higher adhesion and thereby a larger deposition of calcium sulfate. The magnified image of the region of sparse deposition of the foulant sheds light on the fundamental interaction between the foulant and smooth surface, wherein the needle-shaped structures are seen to be well-adhered to smooth surface.

In comparison, for lubricant-infused and solid-infused surfaces, the interaction mechanism is significantly different. FIG. 14B shows that for lubricant-infused surfaces, the foulant deposition spans the composite surface of copper solid asperities and infused lubricant. Similar observations are made for solid-infused surfaces, FIG. 14C, wherein the formation of mesh type calcium sulfate structures is seen equally on both on the infused polymer and the protruding asperities, as marked in the magnified image. However, unlike solid-infused surfaces, some regions of the fouled lubricant-infused surface show dry spots (marked by the yellow circles in the magnified image in FIG. 14B) resulting from drainage of lubricant by the shear of the flowing foulant fluid. The durability aspects of both SIS and LIS are discussed later in this section.

Fouling Resistance Evolution with Time

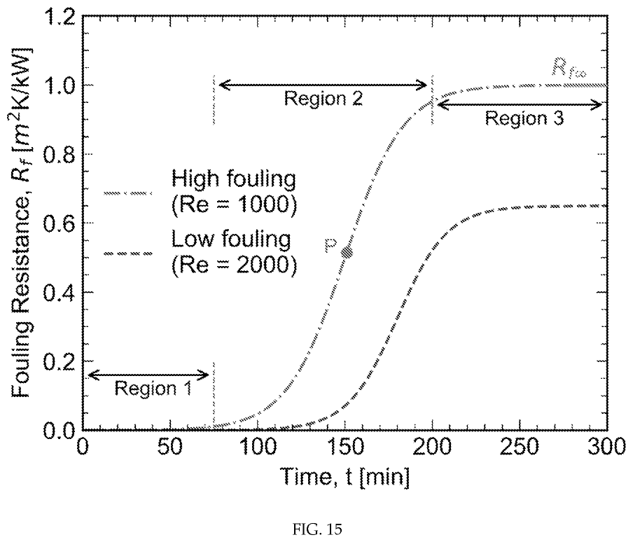

A direct effect of foulant deposition onto surfaces is the reduction in overall heat transfer performance. In the present study, the extent of fouling is quantified by measuring the fouling heat transfer resistance. FIG. 15 illustrates the variation of fouling resistance, R_{f}, with time, t, for two cases of Reynolds numbers, Re=1000 and Re=2000 (T=293 K, c/s=2.5) that lead to high and low fouling of calcium sulfate on solid-infused surface, respectively. For a range of calcium sulfate concentration values used in the present study, the variation of fouling resistance with time follows a sigmoidal growth curve, that may be divided into three regions, as shown in FIG. 15. In the first region, called the induction period, the presence of the fouling agent, calcium sulfate, does not show any effect on the thermal resistance right away. Such a behavior is characteristic of the generation of nucleation spots of fouling agent onto heat transfer surfaces, which will be followed by its growth and spread in later portions of the curve. The duration of the induction period depends on the foulant type and concentration, Reynolds number and temperature, and can vary anywhere from few minutes to several days [Ref. 39]. In FIG. 15, it is seen that the induction period for the conditions leading to high fouling is less than that for the conditions that lead to low fouling, owing to the delay in the nucleation for the lower fouling case.

Following the induction period, the balance between adhesion of foulant particle from the flowing solution onto the heat transfer surface or the previous layer of foulant on the surface and the shear by the flowing fluid that favors the removal of deposited foulant, determines the subsequent dynamics. Following nucleation of foulant particles on the surface during the induction period, continued exposure of the heat transfer surface to the foulant solution results in the growth and spread of calcium sulfate deposits onto the surface leading to a sharp increase in fouling resistance with time, as marked by Region 2 in FIG. 15. This region is marked by a dominate foulant adhesion compared to shear of the flowing fluid, thereby resulting in a rapid rate of increase in fouling resistance with time. However, beyond a certain inflection point, marked by point P in FIG. 15, the effects of shear start to dominate, and the rate of increase of fouling resistance starts to decrease and the end of Region 2 leads to the region of asymptotic fouling, Region 3, as shown in FIG. 15.

In Region 3, the dynamic balance between the rate of foulant deposition due to adhesion onto the surface and the rate of foulant removal due to the shear of flowing fluid leads to a saturated value of fouling resistance, termed as asymptotic fouling resistance, R_{f∞}. Comparing the growth curves for the high and the low fouling cases, the reduced extent of fouling is evident from the lower value of asymptotic fouling resistance, as seen from FIG. 15. Since the asymptotic fouling resistance is a representative metric of fouling and one that is of significance in applications, the analysis in the remainder of this section uses the asymptotic fouling resistance to quantify the effects of the three governing parameters—Re, c/s and T—and, further, to compare the fouling on SIS in comparison to that on smooth and LIS.

### Asymptotic Fouling Resistance

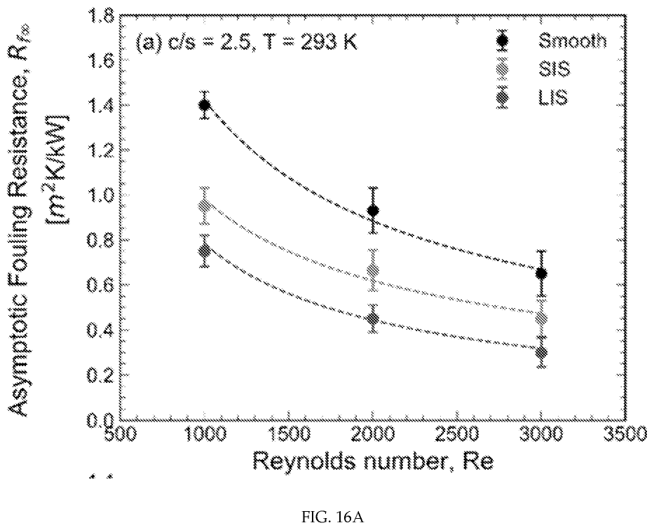

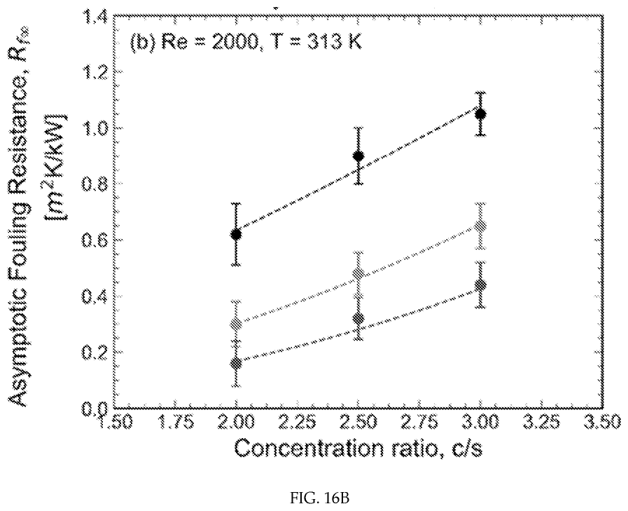

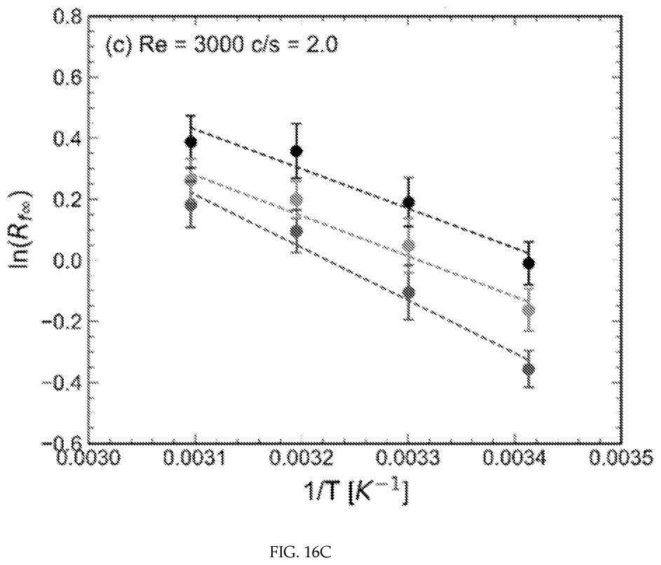

In order to understand the effects of each of the three parameters on the asymptotic fouling resistance, parametric experimental studies were conducted by varying one parameter at a time, keeping the other two parameters fixed, for each of the three surfaces: SIS, LIS and smooth. This amounted to a total of 27 experiments. FIGS. 16A-16C present the results of the parametric study in terms of variation of asymptotic fouling resistance with Reynolds number, dimensionless concentration, and foulant solution temperature, for SIS, LIS and smooth surfaces. In all the plots, the fouling resistance of the two nonwetting surfaces is seen to be consistently lower than that for the conventional smooth surface, for all combinations of parameters presented. Owing to the hydrophobic polymer in the asperity interstices, SIS offers lower adhesion of the foulant and its easy removal by the shear of the flowing fluid, leading to lower asymptotic fouling resistance when compared to smooth surfaces. Similarly, the Krytox 104 lubricant-filled asperities in LIS present far fewer nucleation sites for foulant deposition compared to SIS and smooth surface and show the lowest asymptotic fouling resistance values for all Reynolds number, concentration ratio and foulant temperature. The variation of R_{f∞} with each of the three parameters in FIGS. 16A-16C is examined further in the discussion below.

FIG. 16A shows that with increase in Reynolds number the asymptotic fouling resistance decreases for SIS, LIS and smooth surfaces alike. Increase in Reynolds number results in higher shear by the flowing fluid, leading to higher of foulant deposit removal and, in turn, lower asymptotic fouling resistance. FIG. 16A further suggests that Ry, exhibits a power law variation with Reynolds number that can be expressed in a functional form as:

$${R}_{f ∞} ∝ {Re}^{- a} \qquad ( 5 )$$

where α is a positive constant. The individual best fit power law curves are seen as the dashed lines in FIG. 16A. The power law variation reflects two physical consistency checks that are evident in FIG. 16A for all surface types: (1) as Re→0, the fluid presents vanishing shear for removal of deposited foulant layer and, as a result, the foulant continues to deposit on the surface and the asymptotic fouling resistance approaches to infinity; (2) as R_{f∞}→∞, the flow fluid presents an infinitely large shear that instantaneously removes any adhered deposit leading to zero fouling and zero asymptotic fouling resistance, R_{f∞}→0.

FIG. 16B shows that the asymptotic fouling resistance increases with increase in c/s for all three surface types. Increase in foulant concentration corresponds to a higher amount of foulant in a unit volume of solution, thereby leading to increased deposition and an increase in R_{f∞}. The data in FIG. 16B suggests that regardless of the surface type, the asymptotic fouling resistance increases nonlinearly with c/s that can be represented as a power-law of the form:

$${R}_{f ∞} ∝ {( \frac{c}{s} )}^{b} \qquad ( 6 )$$

where b is a positive constant. The dashed lines in FIG. 16B represent the best-fit power law curves through the data, in which the close match between the data and the fit confirms that the power law variation is an accurate representation. Further, the power law model captures the physical trend that as c/s→0, the flowing fluid has no mineral foulant, and there is no deposition on the surface; i.e., R_{f∞}→0, and that for the other theoretical extreme of c/s→∞, the infinitely abundant availability of foulant in the fluid dominates over the removal by shear of the flowing fluid, leading to R_{f∞}→∞.

The variation of the asymptotic fouling resistance with temperature is presented in a semi-log plot in FIG. 16C. It is evident that R_{f∞} increases with increase in temperature, for three reasons: first, with increase in foulant solution temperature, the solubility of calcium sulfate decreases leading to higher foulant presence per unit volume of the solution for deposition; second, with increase in temperature, the reduction in the interfacial surface tension of water results in higher spreading of foulant solution leading to higher adhesion of foulant to heat transfer surfaces; and third, the deposition and growth kinetics are accelerated with increase in temperature. FIG. 16C shows that for all three surfaces, the measured R_{f∞} data closely follow a linearly decreasing trend with the inverse of the absolute temperature on the semi-log plot, suggesting an Arrhenius dependence of the asymptotic fouling resistance with temperature, given as:

$${R}_{f ∞} ∝ {e}^{- \frac{{T}^{*}}{T}} \qquad ( 7 )$$

where T* is a characteristic temperature in Kelvin. Arrhenius best fit lines through the data are shown by dashed lines in FIG. 16C for three surfaces.
Comparison of SIS with Smooth Surface

Combining the individual functional dependence of R_{f∞} from eqs. 5-7, a unified expression for the asymptotic fouling resistance in terms of Reynolds number, dimensionless concentration and foulant temperature is represented as:

$${R}_{f ∞} = k {{Re}^{- a} ( \frac{c}{s} )}^{b} {e}^{- \frac{{T}^{*}}{T}} \qquad ( 8 )$$

where k is a constant of proportionality, and the four constants, a, b, k, and T* in eq. 8, are determined through a least-squares regression fit of the measured asymptotic fouling resistance data for various combinations of Re, c/s and T.

TABLE 2
Orthogonal array of experiments for calcium sulfate
fouling on SIS and smooth copper surfaces.

| Expt. no. | Re | c/s | T [K] |
|---|---|---|---|
| 1 | 1000 | 2.0 | 293 |
| 2 | 2000 | 2.5 | 293 |
| 3 | 3000 | 3.0 | 293 |
| 4 | 1000 | 2.5 | 303 |
| 5 | 2000 | 3.0 | 303 |
| 6 | 3000 | 2.0 | 303 |
| 7 | 1000 | 3.0 | 313 |
| 8 | 2000 | 2.0 | 313 |
| 9 | 3000 | 2.5 | 313 |
| 10 | 1000 | 2.0 | 323 |
| 11 | 2000 | 3.0 | 323 |
| 12 | 3000 | 2.5 | 323 |

The primary goal of the study is to examine fouling on SIS in comparison to smooth and LIS. To this end, first the fouling mitigation of SIS relative to smooth is explored for combinations of the three factors, Re, c/s, and T, and their respective levels through a partial factorial design of experiments based on an orthogonal array [Ref. 40], as summarized in Table 2. Fouling experiments were conducted on SIS and smooth tubes for the twelve combinations of parameters. The measured values of asymptotic fouling resistance, R_{f∞}^{SIS} and R_{f∞}^{S}, for SIS and smooth tubes, respectively, were used to determine the four constants, a, b, k, and T* in eq. 8 through a least-squares regression fit to obtain:

$${R}_{f ∞}^{SIS} = 305 {{Re}^{- 0.63} ( \frac{c}{s} )}^{2.9} {e}^{- \frac{1325}{T}} \qquad ( 9 a )$$

$${R}_{f ∞}^{S} = 419 {{Re}^{- 0.68} ( \frac{c}{s} )}^{3.14} {e}^{- \frac{1300}{T}} \qquad ( 9 b )$$

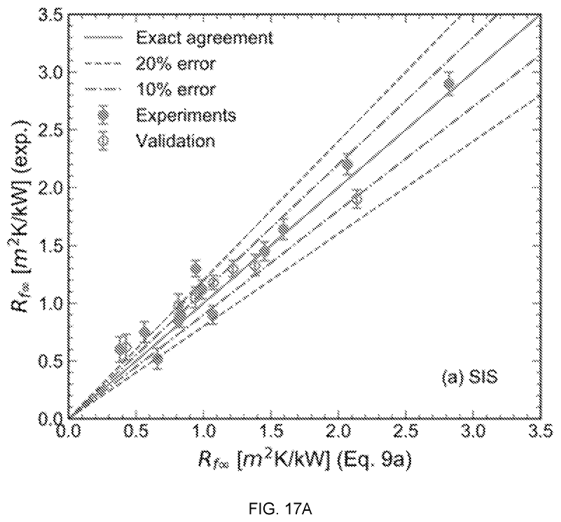

The accuracy of the asymptotic fouling resistance model for calcium sulfate fouling on SIS is examined in FIG. 17A, which compares the experimentally obtained values (red markers) for the 12 experiments in Table 2 with those predicted from eq. 9a. The solid diagonal line is the line of exact agreement, and the dashed lines denote the 10% and 20% error bands around the line of exact agreement. FIG. 17A shows that the model predictions are in close agreement with experimental data, as seen from the closeness of the data to the exact agreement line. Out of 12 experiments, a total of 10 data points fall within the 10% error bounds (to within the experimental errors) and only one data point falls outside the 20% error bounds. Since the 12 data points were used to obtain the regression coefficients in eq. 9a, for an independent validation of the model, an additional 7 experiments listed in Table 3 were conducted that were not used in obtaining the regression coefficients, and the results are included in FIG. 17A as the red open markers. It is noted that all the validation data fall within the 10% error bounds (to within the experimental errors), which demonstrates the validity of the model for further analysis. Collectively, ˜90% of all data fall within 10% error bands and nearly 95% are within 20% error bands. Similarly, FIG. 17B compares the model given by eq. 9b with the experimental data for the 12 runs as per Table 2. The lines in FIG. 17B follow the same notation as in FIG. 17A, and it is seen that 88% data lies within the 10% error bounds and all experimental data points fall within 20% error bounds, confirming the accuracy of the expression given by eq. 9b.

TABLE 3
Additional experiments for the validation of eq. 9a

| Expt. no. | Re | c/s | T [K] |
|---|---|---|---|
| 1 | 2000 | 2.5 | 303 |
| 2 | 2000 | 2.5 | 313 |
| 3 | 2000 | 2.5 | 323 |
| 4 | 1000 | 3.0 | 293 |
| 5 | 2000 | 3.0 | 293 |
| 6 | 2000 | 2.0 | 293 |
| 7 | 2000 | 2.5 | 293 |

Based on the validated empirical models for the asymptotic fouling resistance of SIS and smooth surfaces, a quantitative measure of the fouling mitigation on SIS relative to smooth surface is obtained as the ratio of the reduction in the asymptotic fouling resistance to the fouling resistance on a smooth surface. Expressed as a percentage, the fouling reduction ratio, Δ, is defined as

$$Δ = ( \frac{{R}_{f ∞}^{S} - {R}_{f ∞}^{SIS}}{{R}_{f ∞}^{S}} ) \times 100 \% .$$

Using the empirical models for R_{f∞}^{SIS} (eq. 9a) and R_{f∞}^{S} (eq. 9b), the percentage fouling reduction, Δ, is given by:

$$Δ = 1 - 0.73 {{Re}^{0.05} ( \frac{c}{s} )}^{- 0.24} {e}^{- \frac{25}{T}} \qquad ( 10 )$$

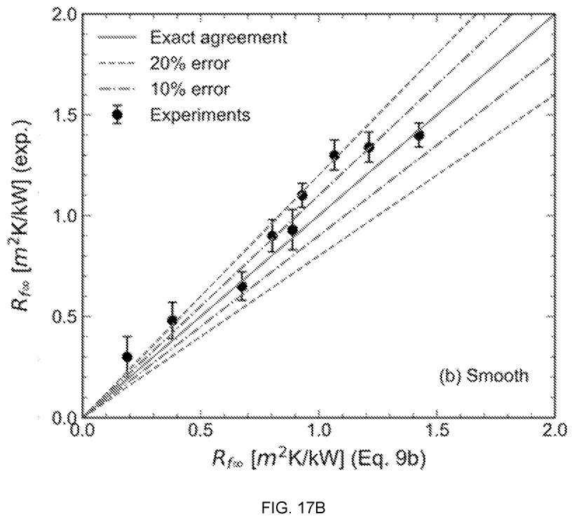

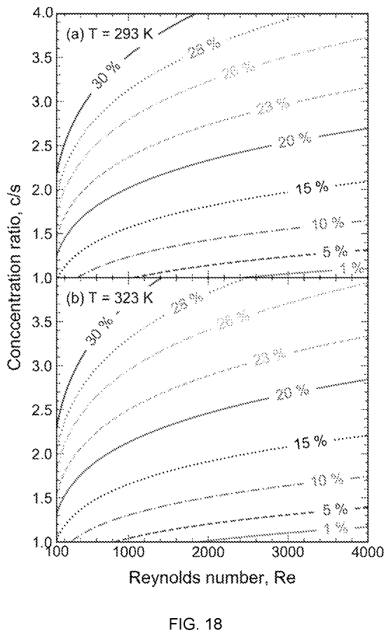

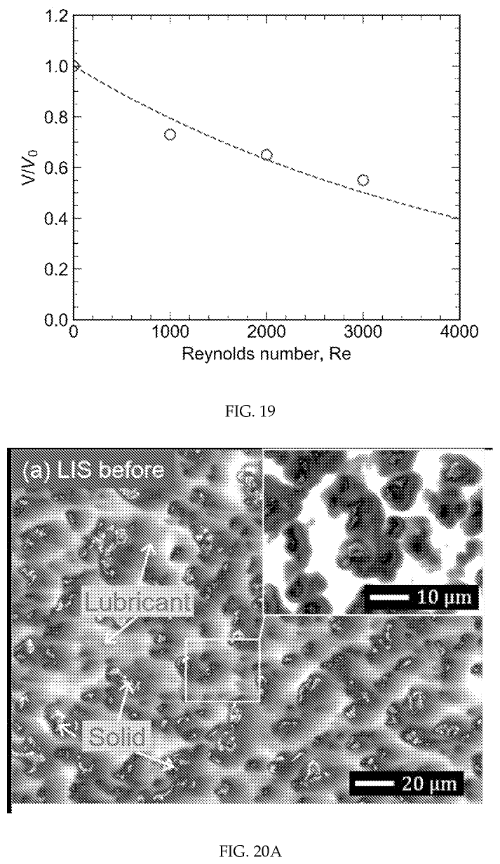

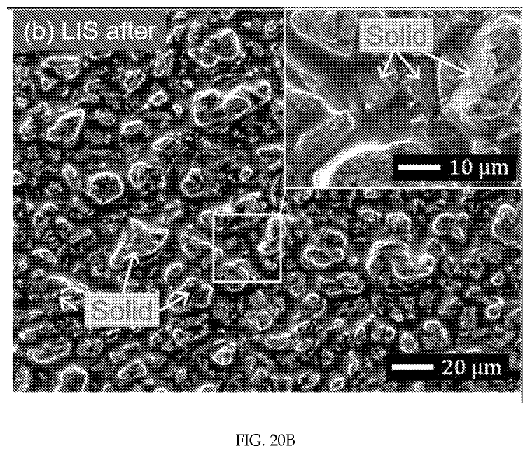

FIGS. 19A-19B show the contours of percentage fouling reduction, Δ, as function of Reynolds number (Re) and foulant concentration ratio (c/s), for two extreme foulant temperature values studied, T=293 K and 323 K, respectively. It is evident from FIG. 18 that for all combinations of Reynolds number and concentration ratio, the percentage fouling reduction values are positive confirming that SIS undergoes consistently lower fouling compared to smooth surfaces. FIGS. 19A-19B show that for a given foulant concentration ratio, increase in Reynolds number reduces A. With increase in flow shear at the higher Reynolds number, the tendency for fouling decreases for both surfaces, reducing the relative fouling mitigation by SIS. Similarly, for a given Reynolds number, increase in foulant concentration results in higher fouling propensity on smooth surface, whereas the SIS is able to reduce the foulant accumulation due to its nonwetting characteristic, resulting in a higher percentage fouling reduction by as much as over 30%. With increase in the temperature of the foulant solution from 293K to 323K, while similar trends are observed in the contours of A with respect to Re and c/s, the fouling reduction percentage through the use of SIS is, in fact, larger for any combination of Re and c/s. In spite of the fact that fouling kinetics is accelerated at the higher temperature, the nonwetting property of SIS inhibits foulant deposition.

Overall, the results in FIGS. 19A-19B demonstrate that SIS is particularly beneficial in situations that are prone to aggressive fouling. FIG. 18 and, equivalently, eq. 10 may be used conveniently to evaluate the fouling mitigation by SIS relative to smooth surface for the parameter combination of Re and c/s. The corresponding asymptotic fouling resistance of SIS may be evaluated using eq. 9a. Equations 9a and 10, therefore, serve as design tools for use of SIS in applications.

### Robustness of SIS and LIS Surfaces

The discussion so far elucidated the superior fouling mitigation by SIS over smooth surface. FIGS. 16A-16C also brought out the fouling inhibition performance of LIS as being greater than that of SIS owing the lower nucleation potential and slippery nature of the lubricant. However, it is well-known that LIS suffers from drainage of infused oil over long exposure to the shear of the fluid flow. It is, therefore, instructive to examine the robustness of the two surfaces, SIS and LIS, in sustaining their respective fouling mitigation characteristic under prolonged exposure to fluid flow.

The durability experiments were conducted by exposing tubes with LIS and SIS on the inside to flow of water without the presence of any foulant for 10 hours at various Reynolds numbers. Each LIS tube was weighed as-textured and functionalized and then after lubricant infusion to get the weight of the infused lubricant as the difference between the post- and pre-infusion weights. The lubricant weight so determined was divided by the lubricant density to obtain the initial lubricant volume, Vₒ. After each 10 h flow run, the LIS tubes were dried for measurement of weight post flow run. The difference in the LIS tube weight after the flow experiment and the as-fabricated and functionalized tube weight corresponded to the retained lubricant and was divided by the lubricant density to estimate the retained lubricant volume, V, after the 10 h continuous flow. The ratio, V/Vₒ, was then used as the retained lubricant volume fraction.

FIG. 19 shows the variation of retained lubricant volume fraction with Reynolds number for Krytox 104 infused LIS. It is evident from the figure that the retained lubricant decreases monotonically with increase in Reynolds number, clearly indicating the extent of drainage at each Re. For a range of Reynolds number considered in the present study, the lubricant loss exceeded 20% for a flow Reynolds number of 1000 and was over 40% at a flow Reynolds number of 3000. The extent of lubricant loss is significant enough to expose the asperity surfaces and attract higher foulant deposition. Similarly, the dry weight of the SIS tubes was measured before and after the flow experiment. There was no discernible difference in the measured weights throughout the Reynolds number range, which suggested that there was no loss of the infused Gentoo polymer during the 10 h flow.

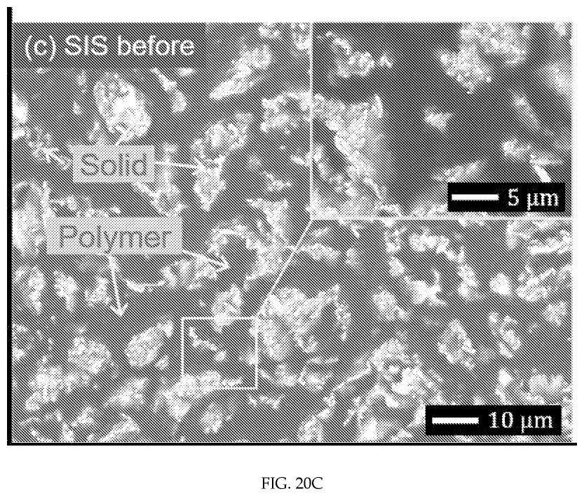

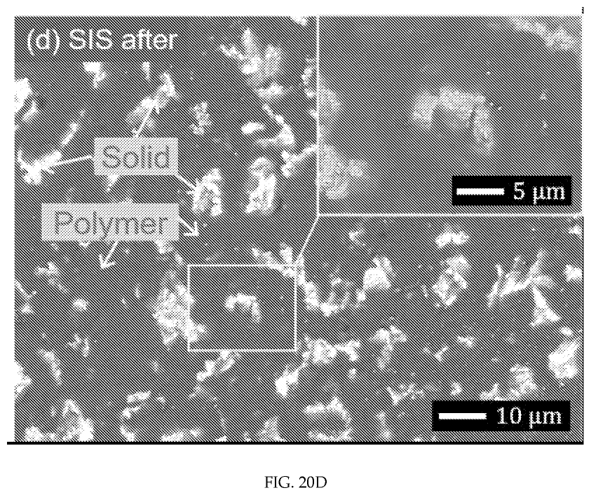

In addition to the retained lubricant volume fraction, the effects of shear flow over LIS and SIS can be seen from the changes in the structural morphology of the surfaces, as elucidated in FIGS. 20A-20D. FIGS. 20A-20D present the scanning electron microscope images of LIS and SIS before and after the 10-hour exposure to fluid flow at Reynolds number value of Re=2000. FIG. 20A shows that as-fabricated lubricant-infused surface (LIS), before the exposure to shear flow, shows the lubricant filled to the top of the solid asperities with the asperity tops visible at the same level as the lubricant. A magnified inset image presents further detail where the bright spots (infused lubricant) are seen present at the level of the top of the solid asperities. However, post shear exposure, the SEM image (FIG. 20B) of LIS shows a clear evidence of the loss of the lubricant. FIG. 20B shows that for the same magnification as that of the before-shear LIS surface (FIG. 20A), the after-shear LIS shows the presence of larger asperities with the lubricant at a lower level in the valleys. In addition, a higher magnification inset image in FIG. 20B shows the exposed lateral sides of the solid asperities which were previously completely covered within the lubricant layer in FIG. 20A. A comparison of FIG. 20A and FIG. 20B presents clear visual proof of the drainage of lubricant from the LIS.

Unlike LIS, the images of solid-infused surfaces in FIGS. 20C-20D reveal a different characteristic. FIG. 20C shows a solid-infused surface at two different magnifications before the shear flow exposure, where the infused polymer is filled in the asperity valleys to about the same height as the solid asperities, as marked in the image. After the shear experiment, the SIS surface in FIG. 20D shows no apparent change in the structural morphology of the composite solid-polymer surface. Unlike LIS, there is no degradation to the surface; the higher magnification inset image in FIG. 20D shows that the polymer fills the asperity valleys to the height of the asperities, just as it was prior to being subject to the prolonged flow, offering a clear proof of the durability of solid-infused surface to prolonged flow exposure.

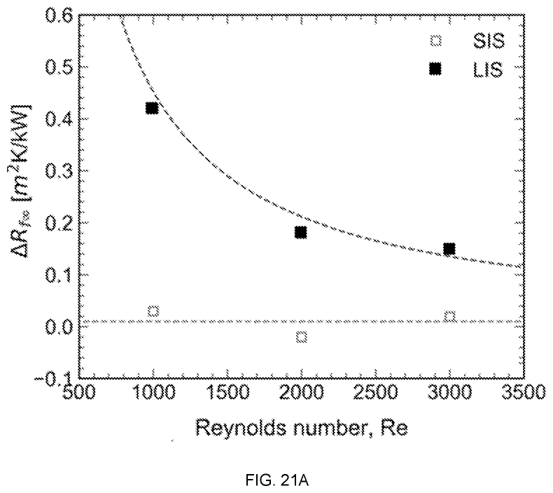

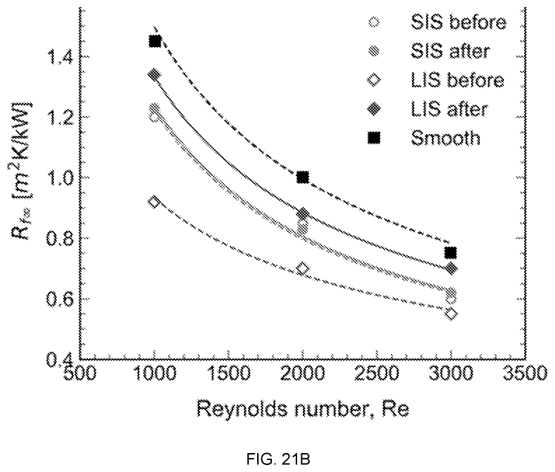

Following the 10 h water flow runs, the LIS and SIS tubes were subject to flow fouling experiments as described in Section 2.4 and the asymptotic fouling resistance was measured. The difference in the asymptotic fouling resistance between the original values (reported in FIGS. 16A-16C) and those measured in the tubes subject to the flow durability experiments was recorded as the differential asymptotic fouling resistance, ΔR_{f∞}. FIG. 21A shows the variation of ΔR_{f∞} with Reynolds number, for SIS and LIS surfaces, where it is evident that LIS shows an increase in R_{f},O after being subjected to flow shear for a period of 10 h, whereas ΔR_{f∞}≈0 for SIS for all Reynolds number values considered in the study. As seen in FIGS. 19 and 9, LIS surface suffered drainage of lubricant oil in a prolonged flow environment, resulting in the exposure of asperities, degradation of nonwetting abilities, and attracting more foulant, leading to ΔR_{f∞}>0 in FIG. 21A. SIS on the other hand sustains its fouling mitigation characteristic owing to no loss of cured polymer from the surface and, in turn, its unchanged wettability properties.

FIG. 21B complements FIG. 21A, with the asymptotic fouling resistance values of LIS and SIS for a range of Reynolds number values, as obtained before and after the durability tests. For comparison, the asymptotic fouling resistance of smooth tube surface is also replotted from FIGS. 16A-16C in FIG. 21B. It is evident from FIG. 21B that SIS surfaces owing to their robustness to the shear flow show insignificant change in the asymptotic fouling resistance values. Krytox-104 infused LIS on the other hand shows a dramatic increase in the asymptotic fouling resistance by as much as 50%, after the prolonged exposure to flow, as seen from FIG. 21B. With the increase in the asymptotic fouling resistance LIS has fouling values comparable to smooth surfaces, whereas SIS maintains a 20% improvement in fouling relative to smooth surface for all Reynolds numbers. Thus, although LIS has a greater fouling reduction compared to smooth surface initially, its advantage diminishes with time in a flow environment, whereas SIS presents a robust alternative for superior fouling mitigation in the long run over a range of operational temperature.

### CONCLUSIONS

In the present article, for the first time, the calcium sulfate fouling mitigation performance of novel solid-infused surfaces is studied in comparison to lubricant-infused and smooth surfaces. Using scanning electron microscopic imaging, the interaction of calcium sulfate foulant with SIS, LIS and smooth surfaces are observed at microscopic length scales. Fouling, quantified in terms of asymptotic fouling resistance, increases with decreasing Reynolds number, and with increasing foulant concentration and temperature. Using systematic design of experiments, empirical models were developed for predicting the asymptotic fouling resistance of SIS and the percentage fouling reduction offered by SIS relative to smooth surface. The models serve as design tools for evaluating the performance advantage of SIS for any combination of Reynolds number, foulant concentration and temperature. It was shown that SIS is particularly effective in situations that are prone to aggressive fouling, with fouling reduction of over 30%. Systematic durability experiments were presented for comparison of the robustness of SIS and LIS when exposed to prolonged flow. It is observed that LIS suffered lubricant volume drainage of over 40% in the range of Reynolds number studied, whereas SIS showed no damage from the prolonged flow. Thus, although LIS has a greater fouling reduction compared to smooth surface initially, its advantage diminishes with time in a flow environment, whereas SIS presents a robust alternative for superior fouling mitigation in the long run over a range of operational temperature.

### REFERENCES FOR EXAMPLE 3

[1] M. Virta, Typical Pre-Commissioning and Start-up Procedures. In HVAC Commissioning Guidebook; CRC Press: London, 2021; p 162.
[2] E. Lee, J. Jeon, H. Kang and Y. Kim, Thermal Resistance in Corrugated Plate Heat Exchangers Under Crystallization Fouling of Calcium Sulfate (CaSO4). International Journal of Heat and Mass Transfer 78 (2014), 908-916. doi:10.1016/j.ijheatmasstransfer.2014.07.069
[3] H. Müller-Steinhagen, Heat transfer fouling: 50 Years After the Kern and Seaton Model. Heat Transfer Engineering 32.1 (2011): 1-13. doi:10.1080/01457632.2010.505127
[4] E. Nebot, J. F. Casanueva, T. Casanueva and D. Sales, Model for Fouling Deposition on Power Plant Steam Condensers Cooled with Seawater: Effect of Water Velocity and Tube Material. Int. J. Heat Mass Transf. (2007), 50 (17-18), 3351-3358. doi:10.1016/j.ijheatmasstransfer.2007.01.022.
[5] K. Nithyanandam, P. Shoaei and R. Pitchumani, Technoeconomic Analysis of Thermoelectric Power Plant Condensers with Nonwetting Surfaces. Energy 227 (2021) 120450. doi:10.1016/j.energy.2021.120450
[6] M. E. Walker, I. Safari, R. B. Theregowda, M. K. Hsieh, J. Abbasian, H. Arastoopour, D. A. Dzombak and D. C. Miller, Economic Impact of Condenser Fouling in Existing Thermoelectric Power Plants, Energy 44 (2012) 429-437. doi:10.1016/j.energy.2012.06.010.
[7] J. Li, Z. Zhai, J. Wang and S. Huang, On-line Fouling Monitoring Model of Condenser in Coal-Fired Power Plants, Appl. Therm. Eng. 104 (2016) 628-635. doi:10.1016/j.applthermaleng.2016.04.131.
[8] W. Ma, Z. Wang, F. Jiao, Y. Zhen and C. Ma Study on Fouling Characteristics of CaCO3 at Low Reynolds Number. Environmental Progress & Sustainable Energy 38.5 (2019): 13163. doi:10.1002/ep.13163
[9] A. P. Watkinson and O. Martinez. Scaling of Heat Exchanger Tubes by Calcium Carbonate. (1975): 504-508. doi:10.1115/1.3450419
[10] E. Lee, J. Jeon, H. Kang and Y. Kim, Thermal Resistance in Corrugated Plate Heat Exchangers Under Crystallization Fouling of Calcium Sulfate (CaSO4). International Journal of Heat and Mass Transfer, 78 (2014) 908-916. doi:10.1016/j.ijheatmasstransfer.2014.07.069
[11] E. Nebot, J. F. Casanueva, T. Casanueva and D. Sales, Model for Fouling Deposition on Power Plant Steam Condensers Cooled with Seawater: Effect of Water Velocity and Tube Material. International Journal of Heat and Mass Transfer, 50 (2007) (17-18), 3351-3358. doi.org/10.1016/j.ijheatmasstransfer.2007.01.022
[12] B. R. Solomon, K. S. Khalil and K. Varanasi, Drag Reduction Using Lubricant-impregnated Surfaces in Viscous Laminar Flow, Langmuir. 30 (2014) 10970-10976. doi:10.1021/la5021143.
[13] S. Hatte and R. Pitchumani, Analytical Model for Drag Reduction on Liquid-infused Structured Non-wetting Surfaces. Soft Matter 17(5) (2021): 1388-1403. doi:10.1039/D0SM01272F
[14] Y. Tuo, H. Zhang, W. Rong, S. Jiang, W. Chen and X. Liu, Drag Reduction of Anisotropic Superhydrophobic Surfaces Prepared by Laser Etching, (2019). doi:10.1021/acs.langmuir.9b01040.
[15] S. Hatte and R. Pitchumani, Fractal Model for Drag Reduction on Multiscale Nonwetting Rough Surfaces. Langmuir 36, no. 47 (2020): 14386-14402. doi: 10.1021/acs.langmuir.0c02790.
[16] K. Kant and R. Pitchumani, Laminar drag reduction in microchannels with liquid infused textured surfaces, Chemical Engineering Science, 230 (2021), 116196. doi.org/10.1016/j.ces.2020.116196
[17] D. Maynes, B. W. Webb and J. Davies, Thermal Transport in a Microchannel Exhibiting Ultrahydrophobic Microribs Maintained at Constant Temperature, J. Heat Transfer. 130 (2008) 1-8. doi:10.1115/1.2789715.
[18] S. Hatte and R. Pitchumani, Analysis of Laminar Convective Heat Transfer Over Structured Non-Wetting Surfaces, Int. J. Heat Mass Transf. 167 (2021) 120810. doi:10.1016/j.ijheatmasstransfer.2020.120810.
[19] S. Hatte and R. Pitchumani, Analysis of Convection Heat Transfer on Multiscale Rough Superhydrophobic and Liquid Infused Surfaces. Chemical Engineering Journal 424 (2021): 130256. doi:10.1016/j.cej.2021.130256
[20] R. Stoddard, K. Nithyanandam and R. Pitchumani, Steam Condensation Heat Transfer on Lubricant-infused Surfaces, IScience. 24 (2021) 102336. doi:10.1016/j.isci.2021.102336.
[21] T. B. Nguyen, S. Park and H. Lim, Effects of Morphology Parameters on Anti-icing Performance in Superhydrophobic Surfaces, Appl. Surf. Sci. 435 (2018) 585-591. doi:10.1016/j.apsusc.2017.11.137.
[22] M. Ruan, W. Li, B. Wang, B. Deng, F. Ma and Z. Yu, Preparation and Anti-icing Behavior of Superhydrophobic Surfaces on Aluminum Alloy Substrates, Langmuir. 29 (2013) 8482-8491. doi:10.1021/la400979d.
[23] S. M. A. Mousavi and R. Pitchumani, A study of Corrosion on Electrodeposited Superhydrophobic Copper Surfaces. Corrosion Science 186 (2021): 109420. doi:10.1016/j.corsci.2021.109420
[24] S. M. A. Mousavi and R. Pitchumani, Bioinspired Nonwetting Surfaces for Corrosion Inhibition over a Range of Temperature and Corrosivity. Journal of Colloid and Interface Science 607 (2021) 323-333. doi:10.1016/j.jcis.2021.08.064
[25] R. Stoddard, K. Nithyanandam and R. Pitchumani, Fabrication and Durability Characterization of Superhydrophobic and Lubricant-infused Surfaces. Journal of Colloid and Interface Science 608 (2022) 662-672. doi.org/10.1016/j.jcis.2021.09.099
[26] M. Cao, D. Guo, C. Yu, K. Li, M. Liu and L. Jiang, Water-repellent properties of superhydrophobic and lubricant-infused “slippery” surfaces: A brief study on the functions and applications. Applied Materials & Interfaces, 8(6) (2016) 3615-3623. doi.org/10.1021/acsami.5b07881
[27] P. Zhang, L. Lin, D. Zang, X. Guo and M Liu, Designing Bioinspired Anti-Biofouling Surfaces based on a Superwettability Strategy. Small, 13(4) (2017) 1503334. doi:10.1002/smll.201503334
[28] M. Ferrari, and A. Benedetti, Superhydrophobic Surfaces for Applications in Seawater. Advances in colloid and interface science, 222 (2015) 291-304. doi:10.1016/j.cis.2015.01.005
[29] J. Genzer, and K. Efimenko, Recent Developments in Superhydrophobic Surfaces and Their Relevance to Marine Fouling: a Review. Biofouling, 22 (5) (2006) 339-360. doi:10.1080/08927010600980223
[30] M. Ferrari, A. Benedetti, E. Santini, F. Ravera, L. Liggieri, E. Guzman and F. Cirisano, Biofouling Control by Superhydrophobic Surfaces in Shallow Euphotic Seawater. Colloids and Surfaces A: Physicochemical and Engineering Aspects, 480 (2015) 369-375. doi:10.1016/j.colsurfa.2014.11.009
[31] W. Jiang, J. He, F. Xiao, S. Yuan, H. Lu and B. Liang, Preparation and Antiscaling Application of Superhydrophobic Anodized CuO Nanowire Surfaces. Industrial & Engineering Chemistry Research, 54(27) (2015) 6874-6883. doi:10.1021/acs.iecr.5b00444
[32] S. Hatte and R. Pitchumani, Generalized Analysis of Dynamic Flow Fouling on Heat Transfer Surfaces. International Journal of Heat and Mass Transfer, 188 (2022) 122573. doi.org/10.1016/j.ijheatmasstransfer.2022.122573
[33] S. B. Subramanyam, G. Azimi and K. K. Varanasi, Designing Lubricant-Impregnated Textured Surfaces to Resist Scale Formation. Advanced Materials Interfaces, 1 (2) (2014) 1300068. doi:10.1002/admi.201300068
[34] W. Jiang, J. He, F. Xiao, S. Yuan, H. Lu and B. Liang, Preparation and Antiscaling Application of Superhydrophobic Anodized CuO Nanowire Surfaces. Industrial & Engineering Chemistry Research, 54(27) (2015) 6874-6883. doi:10.1021/acs.iecr.5b00444
[35] M. F. B. Sousa, G. F. Barbosa, F. Signorelli and C. A. Bertran, Anti-scaling Properties of a SLIPS Material Prepared by Silicon Oil Infusion in Porous Polyaniline Obtained by Electropolymerization. Surface and Coatings Technology, 325 (2017) 58-64. doi:10.1016/j.surfcoat.2017.06.038
[36] J. S. Wexler, I. Jacobi, and H. A. Stone, Shear-driven Failure of Liquid-infused Surfaces. Physical Review Letters, 114(16) (2015) 168301. doi.org/10.1103/PhysRevLett.114.168301
[37] D. Seo, J. Shim, C. Lee and Y. Nam, Brushed lubricant-impregnated surfaces (BLIS) for long-lasting high condensation heat transfer. Scientific reports, 10 (1) (2020), 1-13. doi:10.1038/s41598-020-59683-z
[38] R. Pitchumani and R. Stoddard, Solid Infused Surfaces for High Efficiency Condensation, Provisional U.S. Patent 63/185,973.
[39] H. Müller-Steinhagen, Cooling-Water Fouling in Heat Exchangers. Advances in Heat Transfer, 33 (1999) 414:496. doi.org/10.1016/S0065-2717(08)70307-1
[40] M. S. Phadke, Quality Engineering Using Robust Design (Prentice Hall) (1989).

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

1. An article comprising a solid-infused surface, the solid-infused surface comprising:
a. a substrate comprising a roughened surface having multi-scale surface roughness and a plurality of substrate asperities; and
b. a low surface-energy polymer coating a portion of the roughened surface forming the solid-infused surface having a fraction of the plurality of substrate asperities exposed on the solid-infused surface.

2. The article according to claim 1, wherein the roughened surface has a maximum peak to valley height as measured by a scanning electron microscope of about 5 μm to about 25 μm.

3. The article according to claim 1, wherein the roughened surface has an average roughness of about 2 μm to about 12 μm.

4. The article according to claim 1, wherein the roughened surface has a root mean square roughness of about 2 μm to about 12 μm.

5. The article according to claim 1, wherein the roughened surface has a fractal dimension of about 1.5 to about 2.5.

6. The article according to claim 1, wherein a solid area fraction of the exposed substrate asperities on the solid-infused surface is about 0.02 to about 0.20.

7. The article according to claim 1, wherein the substrate comprises a copper substrate.

8. The article according to claim 1, wherein the substrate comprises a substrate selected from a group consisting of copper, tin, iron, zinc, manganese, carbon, silicon, tin, chromium, phosphorous, alloys thereof, and combinations thereof.

9. The article according to claim 1, wherein the substrate comprises brass, bronze, monel, steel, stainless steel, Inconel, or a combination thereof.

10. The article according to claim 1, wherein the low surface-energy polymer has a water contact angle of about 94° to about 140°.

11. The article according to claim 10, wherein the low surface-energy polymer is selected from a group consisting of nylon, polybutadiene, polyethylene (PE), polychlorotrifluoroethylene (PCTFE), polypropylene (PP), polydimethylsiloxane (PDMS), poly t-butyl methacrylate (PtBMA), fluorinated ethylene propylene (FEP), hexatriacontane, paraffin, polytetrafluoroethylene (PTFE), poly(hexafluoropropylene), polyisobutylene (PIB, butyl rubber), silicone, polyester, polyester, polyurethane, copolymers, thereof, and blends thereof.

12. The article according to claim 11, wherein the low surface-energy polymer comprises a Gentoo® polymer.

13. The article according to claim 1, wherein the solid-infused surface has an asymptotic fouling resistance that is reduced by at least 10% when compared to the asymptotic fouling resistance of a smooth untreated surface of an otherwise same substrate when measured under otherwise same conditions.

14. The article according to claim 1, wherein the solid-infused surface exhibits a reduction in a foulant accumulation of at least 30% when compared to a foulant accumulation for a smooth untreated surface of an otherwise same substrate when measured under otherwise same conditions.

15. The article according to claim 14, wherein the foulant is selected from sulfates, nitrates, phosphates, calcium, lime, and a combination thereof.

16. The article according to claim 1, wherein the article is an inner or outer surface of a pipe or conduit.

17. The article according to claim 16, wherein the pipe or conduit is a part of a radiator.

18. The article according to claim 1, wherein the article is a solar panel or a component thereof.

19. The article according to claim 1, wherein the article is selected from a group consisting of a container, a pipeline, nozzle, valve, a conduit, a vessel, a bottle, a mold, a die, a chute, a bowl, a tub, a bin, a cap for a bottle or container, a tube, and a combination thereof.

20. A method of making a solid-infused surface on an article, the method comprising:
a. roughening a surface of a substrate to produce a roughened surface having multi-scale surface roughness and a plurality of substrate asperities; and
b. coating a portion of the roughened surface with a low surface-energy polymer to form the solid-infused surface having a fraction of the plurality of substrate asperities exposed on the solid-infused surface.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
